(19) United States
(12) Patent Application Publication
(10) Pub. No.: US 2015/0142182 A1
(43) Pub. Date: May 21, 2015

(54) ACTIVE ANTI-VIBRATION APPARATUS, ANTI-VIBRATION METHOD, PROCESSING DEVICE, INSPECTION DEVICE, EXPOSURE DEVICE, AND WORKPIECE MANUFACTURING METHOD

(71) Applicant: CANON KABUSHIKI KAISHA, Tokyo (JP)

(72) Inventors: Ryuji Kimura, Kawasaki-shi (JP); Kosuke Suemura, Kawasaki-shi (JP)

(21) Appl. No.: 14/402,058

(22) PCT Filed: Jul. 30, 2013
(86) PCT No.: PCT/JP2013/071093

§ 371 Date: Nov. 18, 2014

(30) Foreign Application Priority Data
Aug. 3, 2012 (JP) 2012-172736
Jul. 26, 2013 (JP) 2013-155914

(51) Int. Cl. F16F 15/00; F16F 15/023; G05B 15/02; F16M 11/22

(52) U.S. Cl. CPC F16F 15/002; F16M 11/22; F16F 15/0232; G05B 15/02
USPC 700/280; 248/550

(57) ABSTRACT

An active anti-vibration apparatus is provided that supports a wide range of vibration accelerations using only one type of anti-vibration mechanism. Upon occurrence of an excessive acceleration, the active anti-vibration apparatus performs switching such that an acceleration detection gain 14b of an acceleration amplifier 14 is multiplied by a prescribed magnification, the cutoff frequency of a high-pass filter 11a of a vibration control unit 11 is increased, and an acceleration control gain 11b of the vibration control unit 11 is multiplied by the reciprocal of the prescribed magnification.

### TECHNICAL FIELD

The present invention relates to an active anti-vibration apparatus, an anti-vibration method, processing device, an inspection device, an exposure device and a workpiece manufacturing method.

### BACKGROUND ART

One of anti-vibration apparatuses on which precise measurement processing devices and semiconductor exposure devices can be mounted is an active anti-vibration apparatus that allows actuators, such as linear motors, to attenuate the characteristic vibrations of air springs. The active anti-vibration apparatus is required to maintain an anti-vibration function against a wide range of acceleration levels from a normal acceleration level to an acceleration caused according to movement of a mounted object and further to an excessive acceleration level, such as of a moderate earthquake. Thus, it is required to monitor accelerations and vibration states to determine the states, and select an appropriate control method.

In particular, upon occurrence of an excessive acceleration, such as of an earthquake, the active anti-vibration apparatus switches control and maintains an active anti-vibration state, determines vibration states based on a detected acceleration, and returns to a state of allowing a maximum anti-vibration performance to be exhibited. The apparatus is also required to transition to a safer state in abnormality.

Conventionally, there has been an anti-vibration apparatus including a unit of performing control such that, upon occurrence of an excessive acceleration, an absolute vibration control according to which a normal output of an acceleration sensor is compensated and fed back to an actuator is switched to a relative position control according to which an output from the displacement sensor is compensated. That is, a method is adopted according to which, upon occurrence of an abnormal acceleration, the control is switched to the relative position control, and the absolute vibration control is not performed, which prevents the anti-vibration apparatus from vibrating and maintains a floating state. However, if the absolute vibration control is switched to the relative position control, the anti-vibration state can be maintained but performance against onboard vibrations according to floor vibrations, that is, an anti-vibration performance is unfortunately reduced.

A monitoring mechanism has been proposed which is for a damping apparatus incorporated in a building and which monitors a damping force and a vibration velocity to monitor whether a damping operation is normally performed or not. However, this monitoring mechanism has an object to monitor whether the damping apparatus normally performs the damping operation, and to cause the apparatus to transition to a safe state in case of abnormality. Accordingly, no consideration is paid for returning to a normal damping operation.

Furthermore, there has been an active anti-vibration apparatus that detects an earthquake based on a square integration value of control current of acceleration feedback loop, and switches an actuator to an actuator that is supplied with an output when an earthquake is detected, thereby maintaining an active control state. However, the active anti-vibration apparatus has an object to avoid an error stop of the apparatus due to excessive control current for a normally used linear motor actuator, upon occurrence of an earthquake. Accordingly, the apparatus has a slower response speed than an anti-vibration apparatus of directly detecting a vibration state, such as of an earthquake, by an acceleration sensor has.

PTL 1 proposes an anti-vibration apparatus on which two types of anti-vibration mechanisms that are large and small are mounted and which switches the anti-vibration mechanism to be used according to the vibration level to support a wide range of vibration accelerations from micro vibrations, such as device noise, to excessive vibrations, such as of an earthquake. However, the apparatus is complicated by providing the two anti-vibration mechanisms, which leads to increase in cost as a result.

### CITATION LIST

### Patent Literature

PTL 1: Japanese Patent Application Laid-Open No. 2000-170827

### SUMMARY OF INVENTION

### Technical Problem

As described above, to support the wide range of vibration accelerations from micro vibrations caused by device noise to excessive vibrations caused by an earthquake, the two types of anti-vibration mechanisms that are large and small are mounted on the anti-vibration apparatus disclosed in PTL 1, and the anti-vibration mechanism to be used is switched according to the vibration level. However, this configuration causes the apparatus to be complicated, which leads to increase in cost as a result.

Thus, the present invention allows only one type of anti-vibration mechanism to support a wide range of vibration accelerations. Accordingly, an active anti-vibration apparatus can be provided that is not complicated and does not lead to increase in cost.

### Solution to Problem

The present invention provides an active anti-vibration apparatus, including: a mount mounted on a floor; an anti-vibration table which is mounted on the mount and on which a device is mounted; at least one acceleration sensor for detecting an acceleration pertaining to the anti-vibration table; an acceleration amplifier which multiplies a signal output from the acceleration sensor by a setting value to amplify the signal; a vibration control unit which calculates a signal for compensating the acceleration from an output of the acceleration amplifier; an excessive acceleration determination and switching unit which determines whether the acceleration detected by one or more of the at least one acceleration sensor is at least a prescribed acceleration or not, and changes the setting value according to the determination; and an actuator driven according to the signal output from the vibration control unit.

A processing device according to the present invention is mounted on the active anti-vibration apparatus. An inspection device according to the present invention is mounted on the active anti-vibration apparatus. An exposure device according to the present invention is mounted on the active anti-vibration apparatus. The present invention provides an active anti-vibration method for suppressing vibrations of an anti-vibration table by detecting an acceleration pertaining to the anti-vibration table on which a device is mounted, calculating a control signal for driving an actuator so as to compensate the acceleration based on the detected acceleration, and driving the actuator according to the calculated control signal, the method including: detecting an acceleration pertaining to the anti-vibration table by at least one acceleration sensor; and if the detected acceleration is at least a prescribed acceleration, multiplying a signal output from the acceleration sensor by a setting value to change the signal, and calculating the control signal based on the changed signal and subsequently driving the actuator according to a signal acquired by multiplying the control signal by the reciprocal of the setting value.

The present invention provides a workpiece manufacturing method of manufacturing a workpiece by a device mounted on an anti-vibration table vibrations of which are eliminated by the anti-vibration method, the method including: if the detected acceleration is at least the prescribed acceleration, terminating manufacturing of the workpiece, and, when an integrated value of the detected acceleration in a prescribed time period after the terminating is equal to or less than a prescribed integrated threshold, restarting manufacturing the workpiece; and when the integrated value exceeds the prescribed integration threshold, stopping manufacturing the workpiece.

### Advantageous Effects of Invention

According to the present invention, only one type of anti-vibration mechanism can support the wide range of vibration accelerations from micro vibrations caused by device noise to excessive vibrations caused by an earthquake.

Further features of the present invention will become apparent from the following description of exemplary embodiments with reference to the attached drawings.

### BRIEF DESCRIPTION OF DRAWINGS

FIG. 1 is a transparent perspective view of an active anti-vibration apparatus 50 according to this embodiment.

FIG. 2A is a block diagram of the active anti-vibration apparatus 50 according to this embodiment.

FIG. 2B is a block diagram of the active anti-vibration apparatus 50 according to this embodiment.

FIG. 3A is a diagram schematically illustrating the temporal variations of output values of acceleration sensors 4a to 4f in a case of temporary occurrence of excessive positional change in the active anti-vibration apparatus 50 according to this embodiment.

FIG. 3B is a diagram schematically illustrating the temporal variation of an output value of an acceleration amplifier 14 in a case of temporary occurrence of excessive positional change in the active anti-vibration apparatus 50 according to this embodiment.

FIG. 3C is a diagram schematically illustrating the temporal variations of output values of acceleration sensors 4a to 4f in a case of temporary occurrence of excessive change in acceleration in the active anti-vibration apparatus 50 according to this embodiment.

FIG. 3D is a diagram schematically illustrating the temporal variation of an output value of the acceleration amplifier 14 in a case of temporary occurrence of excessive change in acceleration in the active anti-vibration apparatus 50 according to this embodiment.

FIG. 4A is a flowchart illustrating a process upon occurrence of an excessive acceleration in the active anti-vibration apparatus 50 according to this embodiment.

FIG. 4B is a flowchart illustrating a process after occurrence of an excessive acceleration in the active anti-vibration apparatus 50 according to this embodiment.

FIG. 5A is a diagram illustrating behavior of an acceleration a[i] after switching a setting value for each configurational element of the active anti-vibration apparatus 50 according to this embodiment upon occurrence of an excessive acceleration.

FIG. 5B is a diagram illustrating behavior of the acceleration a[i] after switching a setting value for each configurational element of the active anti-vibration apparatus 50 according to this embodiment upon occurrence of an excessive acceleration.

FIG. 6A is a perspective view of an active anti-vibration apparatus 60 on which a processing device 70 is mounted and to which this embodiment is applied.

FIG. 6B is a block diagram pertaining to signal transmission and reception between a system of the processing device 70 and a system of the anti-vibration apparatus 60.

FIG. 7A is a flowchart corresponding to monitoring of a processing procedures in a processing device mounted on the active anti-vibration apparatus according to this embodiment.

FIG. 7B is a flowchart corresponding to evaluation of a result of the processing procedures in the processing device mounted on the active anti-vibration apparatus according to this embodiment.

FIG. 7C is a diagram specifically illustrating a log file 40.

FIG. 8A is a flowchart corresponding to monitoring of an inspection process in an inspection device mounted on the active anti-vibration apparatus according to this embodiment.

FIG. 8B is a flowchart corresponding to evaluation of a result of the inspection process in the inspection device mounted on the active anti-vibration apparatus according to this embodiment.

FIG. 9A is a flowchart illustrating a process of manufacturing a semiconductor chip.

FIG. 9B is a flowchart corresponding to monitoring of an exposure process on a device by an exposure device mounted on the active anti-vibration apparatus according to this embodiment.

FIG. 9C is a flowchart corresponding to evaluation of a result of the exposure process on the device by the exposure device mounted on the active anti-vibration apparatus according to this embodiment.

### DESCRIPTION OF EMBODIMENTS

Embodiment of the present invention will hereinafter be described with reference to drawings. The drawings illustrated below may be drawn in a scale different from an actual case for facilitating understanding of the present invention.

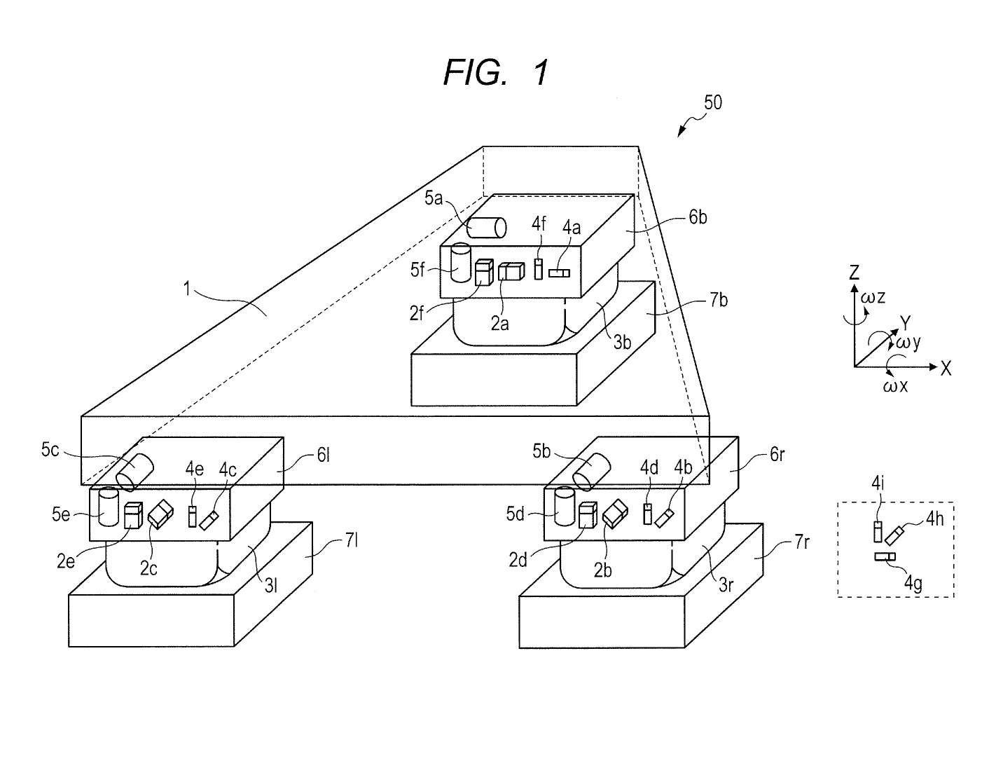

FIG. 1 is a transparent perspective view of an active anti-vibration apparatus 50 according to this embodiment.

The active anti-vibration apparatus 50 includes: lower mounts 7b, 71 and 7r mounted on a floor (not illustrated); and air spring actuators 3b, 3l and 3r mounted on the respective lower mounts 7b, 71 and 7r. The active anti-vibration apparatus 50 further includes: upper mounts 6b, 61 and 6r mounted on the respective air spring actuators 3b, 3l and 3r; and an anti-vibration table 1 mounted on the upper mounts 6b, 61 and 6r. A device (not illustrated) is mounted on the anti-vibration table 1. The lower mounts, the air spring actuators and the upper mounts are sometimes collectively called mounts.

The upper mount 6b is provided with displacement sensors 2a and 2f, acceleration sensors 4a and 4f, and linear motors 5a and 5f. The upper mount 61 is provided with displacement sensors 2c and 2e, acceleration sensors 4c and 4e, and linear motors 5c and 5e. The upper mount 6r is provided with displacement sensors 2b and 2d, acceleration sensors 4b and 4d, and linear motors 5b and 5d. Floor acceleration sensors 4g, 4h and 4i are provided on a floor (not illustrated). These displacement sensors, acceleration sensors and linear motors may be provided on places different from the upper mounts only if the sensors and the motors can exhibit functions.

The displacement sensor 2a detects a displacement in an X direction. The displacement sensors 2b and 2c detect respective displacements in a Y direction. The displacement sensors 2d, 2e and 2f detect respective displacements in a Z direction. The displacement sensors 2b and 2c are on respective different axes parallel to the Y-axis. The displacement sensors 2d, 2e and 2f are on respective different axes parallel to the Z-axis.

The outputs of displacement sensors 2a to 2f are combined in this configuration, thereby allowing detection of displacements in the X, Y and Z-axes directions and angular variations about the X, Y and Z-axes of the gravity center in a system that has six degrees of freedom and adopts the gravity center as the origin. Here, the gravity center is a total gravity center of all the objects supported by the air spring actuators 3b, 3l and 3r while the objects are regarded as one rigid body; the objects are, for instance, a mounted device (not illustrated) and the anti-vibration table 1. The gravity center, which will be described later, means this total gravity center.

Each of the air spring actuators 3b, 3l and 3r can be displaced along two axes in the horizontal and vertical directions. More specifically, the air spring actuator 3b is displaced in the X and Z directions. Each of the air spring actuators 3l and 3r is displaced in the Y and Z directions. Here, with respect to the Y-axis, the air spring actuators 3l and 3r are on respective different axes parallel to the Y-axis. With respect to the Z-axis, the air spring actuators 3b, 3l and 3r are on respective different axes parallel to the Z-axis. According to this configuration, the air spring actuators 3b, 3l and 3r may combine the displacements to thereby be displaced in the X, Y and Z-axes directions and about the X, Y and Z-axes in the system that has six degrees of freedom and adopts the gravity center as the origin, as desired.

Thus, the displacement on the anti-vibration table can be suppressed. Here, for simplifying mathematical expressions, the configuration in the system that has six degrees of freedom and adopts the gravity center as the origin will be described. However, the system may be an coordinate system that adopts any point as an origin. Instead, the configuration can be achieved in a system with three degrees of freedom.

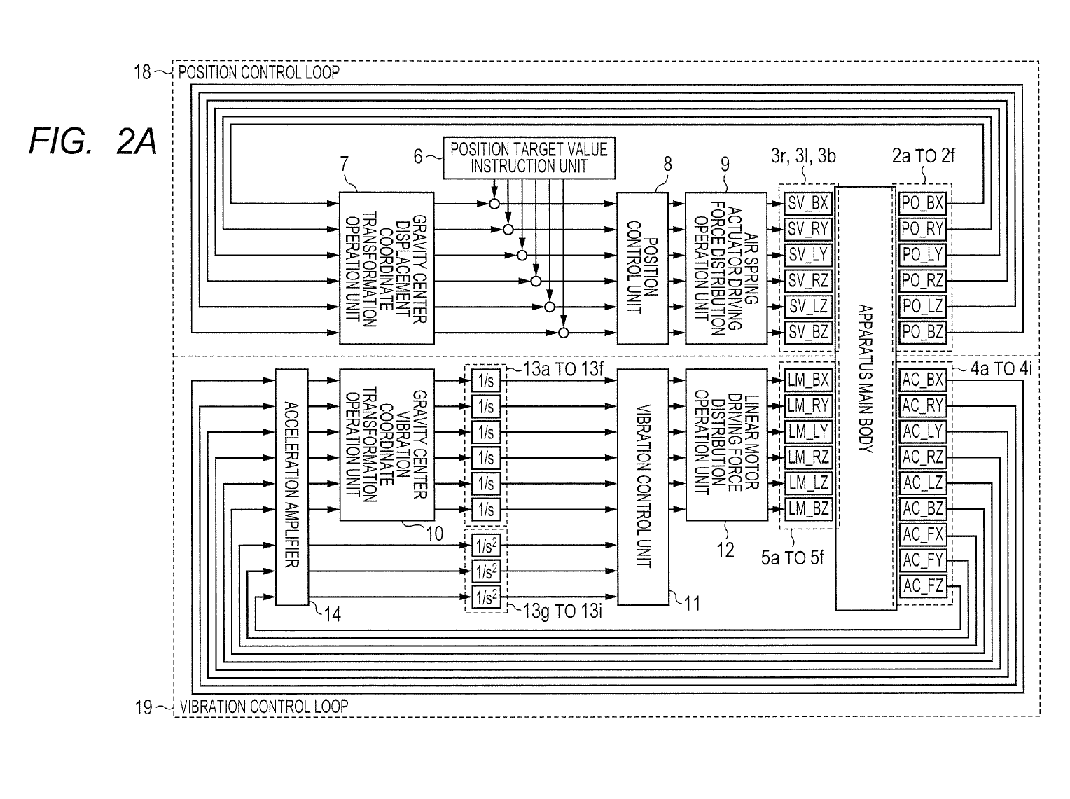

FIG. 2A illustrates a block diagram of the active anti-vibration apparatus 50 in this embodiment.

A position control loop 18 for position control in the active anti-vibration apparatus 50 will hereinafter be described with reference to mathematical expressions.

The position control loop 18 includes the displacement sensors 2a to 2f, a gravity center displacement coordinate transformation operation unit 7, a position target value instruction unit 6, a position control unit 8, an air spring actuator driving force distribution operation unit 9, and the air spring actuators 3b, 3l and 3r.

The gravity center displacement coordinate transformation operation unit 7 computes the displacements of the gravity center in the X, Y and Z-axes and the angular variations about the X, Y and Z-axes in the system that has six degrees of freedom and adopts the gravity center as the origin, from the outputs of the displacement sensors 2a to 2f. The output values of the displacement sensors 2a to 2f are represented by the following Expression (1), from the positional relationship between the displacement sensors, with respect to the displacements of the gravity center in the axes and the angular variations about the axes, in the system that has six degrees of freedom and adopts the gravity center as the origin.

$${P}_{P} = {T}_{P} \cdot {P}_{G} \\ {P}_{P} = [ \begin{matrix}{p}_{bx} \\ {p}_{ry} \\ {p}_{ly} \\ {p}_{rz} \\ {p}_{lz} \\ {p}_{bz}\end{matrix} ] , {P}_{G} = [ \begin{matrix}{px}_{G} \\ {py}_{G} \\ {pz}_{G} \\ p ω {x}_{G} \\ p ω {y}_{G} \\ p ω {z}_{G}\end{matrix} ] \\ {T}_{P} = [ \begin{matrix}1 & 0 & 0 & 0 & {z}_{Pbx} & - {y}_{Pbx} \\ 0 & 1 & 0 & - {z}_{Pry} & 0 & {x}_{Pry} \\ 0 & 1 & 0 & - {z}_{Ply} & 0 & {x}_{Ply} \\ 0 & 0 & 1 & {y}_{Prz} & - {x}_{Prz} & 0 \\ 0 & 0 & 1 & {y}_{Plz} & - {x}_{Plz} & 0 \\ 0 & 0 & 1 & {y}_{Pbz} & - {x}_{Pbz} & 0\end{matrix} ] \qquad ( 1 )$$

Here, P_{P} is the output values of the displacement sensors 2a to 2f, more specifically, p_{bx}, p_{ry}, p_{ly}, p_{rz}, p_{lz} and p_{bz} are the output values of the respective displacement sensors 2a, 2b, 2c, 2d, 2e and 2f. P_{G} is the displacements of the gravity center in the axes and angular variations about the axes in the system that has six degrees of freedom and adopts the gravity center as the origin. More specifically, px_{G}, py_{G} and pz_{G} are displacements in the respective X, Y and Z-axes directions. pωx_{G}, pωy_{G} and pωz_{G} are angular variations about the respective X, Y and Z-axes. Furthermore, the coefficients in a matrix T_{P} are determined according to the coordinates of detected points of the displacement sensors 2a to 2f in the coordinate system that adopts the gravity center as the origin. More specifically, y_{Pbx} and z_{Pbx} are the respective Y and Z coordinate values of the displacement sensor 2a. x_{Pry} and z_{Pry} are the respective X and Z coordinate values of the displacement sensor 2b. x_{Ply} and z_{Ply} are the respective X and Z coordinate values of the displacement sensor 2c. Furthermore, x_{Prz} and y_{Prz} are the respective X and Y coordinate values of the displacement sensor 2d, x_{Plz} and y_{Plz} are the respective X and Y coordinate values of the displacement sensor 2e. x_{Pbz} and y_{Pbz} are the respective X and Y coordinate values of the displacement sensor 2f.

According to Expression (1), an expression for acquiring the displacement of the gravity center from the output value of each displacement sensor is represented as the following Expression (2).

P_{G}=T_{P}⁻¹·P_{P} (2)

Here, a gravity center displacement coordinate transformation matrix T_{P}⁻¹ is represented. The gravity center displacement coordinate transformation operation unit 7 outputs a value acquired by multiplying the output values P_{P} of the displacement sensors 2a to 2f having been input and the gravity center displacement coordinate transformation matrix T_{P}⁻¹ together, that is, a signal corresponding to the displacements of the gravity center in the axes and the angular variations P_{G} about the axes in the system that has six degrees of freedom and adopts the gravity center as the origin.

The deviation between the output value of the position target value instruction unit 6 that corresponds to the position target value for the gravity center and the output value of the gravity center displacement coordinate transformation operation unit 7 is input into the position control unit 8, and a PI compensator computes a position control input.

The air spring actuator driving force distribution operation unit 9 computes inputs required to appropriately displace the air spring actuators 3b, 3l and 3r, from desired position control inputs for the respective axes in the system that has six degrees of freedom and adopts the gravity center as the origin; the inputs are output from the position control unit 8. Here, the desired position control input is a position control input for compensating the displacement of the gravity center.

With respect to the output values of the air spring actuators 3b, 3l and 3r, translational forces in the axes and torques about the axes for compensating the displacements of the gravity center in the system that has six degrees of freedom and adopts the gravity center as the origin are represented from the positional relationship between the air spring actuators by the following Expression (3).

$${F}_{GS} = {T}_{S} \cdot {F}_{S} \\ {F}_{GS} = [ \begin{matrix}{F}_{Sx} \\ {F}_{Sy} \\ {F}_{Sz} \\ {T}_{Sx} \\ {T}_{Sy} \\ {T}_{Sz}\end{matrix} ] , {F}_{S} = [ \begin{matrix}{F}_{Sbx} \\ {F}_{Sry} \\ {F}_{Sly} \\ {F}_{Srz} \\ {F}_{Slz} \\ {F}_{Sbz}\end{matrix} ] \\ {T}_{S} = [ \begin{matrix}1 & 0 & 0 & 0 & 0 & 0 \\ 0 & 1 & 1 & 0 & 0 & 0 \\ 0 & 0 & 0 & 1 & 1 & 1 \\ 0 & - {z}_{Sry} & - {z}_{Sly} & {y}_{Srz} & {y}_{Slz} & {y}_{Sbz} \\ {z}_{Sbx} & 0 & 0 & - {x}_{Srz} & - {x}_{Slz} & - {x}_{Sbz} \\ - {y}_{Sbx} & {x}_{Sry} & {x}_{Sly} & 0 & 0 & 0\end{matrix} ] \qquad ( 3 )$$

Here, F_{S} is output values of the air spring actuators 3b, 3l and 3r. More specifically, F_{Sbx}, F_{Sry}, F_{Sly}, F_{Srz}, F_{Slz} and F_{Sbz} are output values of the air spring actuator 3b in the X direction, of the actuator 3r in the Y direction, of the actuator 3l in the Y direction, of the actuator 3r in the Z direction, of the actuator 3l in the Z direction, and of the actuator 3b in the Z direction. F_{GS} is the translational forces in the axes and the torques about the axes in the system that has six degrees of freedom and adopts the gravity center as the origin. More specifically, F_{Sx}, F_{Sy} and F_{Sz} are the respective translational forces in the X, Y and Z-axes directions. T_{Sx}, T_{Sy} and T_{Sx} are the respective torques about the X, Y and Z-axes. The coefficients in the matrix T_{S} are determined according to the coordinates of the points of application of the air spring actuators 3b, 3l and 3r in the system that has six degrees of freedom and adopts the gravity center as the origin. More specifically, y_{Sbx} and z_{Sbx} are the Y and Z coordinate values of the points of application for the output of the air spring actuator 3b in the X direction. x_{Sry} and z_{Sry} are the X and Z coordinate values of the points of application for the output of the air spring actuator 3r in the Y direction. x_{Sly} and z_{Sly} are the X and Z coordinate values of the points of application for the output of the air spring actuator 3l in the Y direction. x_{Srz} and y_{Srz} are the X and Y coordinate values of the points of application for the output of the air spring actuator 3r in the Z direction. x_{Slx} and y_{Slz} are the X and Y coordinate values of the points of application for the output of the air spring actuator 3l in the Z direction. x_{Sbz} and y_{Sbz} are the X and Y coordinate values of the points of application for the output of the air spring actuator 3b in the Z direction.

According to Expression (3), an expression for acquiring an output value required to displace each air spring actuator with respect to the desired translational forces in the axes and the desired torque about the axes in the system that has six degrees of freedom and adopts the gravity center as the origin is represented by the following Expression (4).

F_{S}=T_{S}⁻¹·F_{GS} (4)

Here, an air spring actuator driving force distribution matrix T_{S}⁻¹ is represented. The air spring actuator driving force distribution operation unit 9 outputs a value acquired by multiplying the output value F_{GS} of the position control unit 8 having been input and the air spring actuator driving force distribution matrix T_{S}⁻¹ together, to each air spring actuator, thereby performing position control.

In this embodiment, the air spring actuators (second actuators) are adopted for compensating the displacement. However, the actuators are not limited thereto.

Next, a vibration control loop 19 for vibration control in the active anti-vibration apparatus 50 will be described.

The active anti-vibration apparatus includes at least one acceleration sensor for detecting an acceleration pertaining to the anti-vibration table.

For instance, as illustrated in FIG. 1, the acceleration sensor 4a detects an acceleration in the X direction. The acceleration sensors 4b and 4c detect accelerations in the Y direction. The acceleration sensors 4d, 4e and 4f detect accelerations in the Z direction. Here, the acceleration sensors 4b and 4c are on different axes parallel to the Y-axis, and the acceleration sensors 4d, 4e and 4f are on different axes parallel to the Z-axis. The output values of the acceleration sensors 4a to 4f are combined according to this configuration, which can detect the accelerations of the gravity center in the X, Y and Z-axes directions and the angular accelerations of the gravity center about the X, Y and Z-axes in the system that has six degrees of freedom and adopts the gravity center as the origin.

With respect to the accelerations of the gravity center in the axes and the angular accelerations of the gravity center about the axes in the system that has six degrees of freedom and adopts the gravity center as the origin, the output values of the acceleration sensors 4a to 4f are represented from the positional relationship between the acceleration sensors by the following Expression (5).

$${A}_{A} = {T}_{A} \cdot {A}_{G} \\ {A}_{A} = [ \begin{matrix}{a}_{bx} \\ {a}_{ry} \\ {a}_{ly} \\ {a}_{rz} \\ {a}_{lz} \\ {a}_{bz}\end{matrix} ] , {A}_{G} = [ \begin{matrix}{ax}_{G} \\ {ay}_{G} \\ {az}_{G} \\ a ω {x}_{G} \\ a ω {y}_{G} \\ a ω {z}_{G}\end{matrix} ] \\ {T}_{A} = [ \begin{matrix}1 & 0 & 0 & 0 & {z}_{Abx} & - {y}_{Abx} \\ 0 & 1 & 0 & - {z}_{Ary} & 0 & {x}_{Ary} \\ 0 & 1 & 0 & - {z}_{Aly} & 0 & {x}_{Aly} \\ 0 & 0 & 1 & {y}_{Arz} & - {x}_{Arz} & 0 \\ 0 & 0 & 1 & {y}_{Alz} & - {x}_{Alz} & 0 \\ 0 & 0 & 1 & {y}_{Abz} & - {x}_{Abz} & 0\end{matrix} ] \qquad ( 5 )$$

Here, A_{A} is values that are the outputs of the acceleration amplifier 14 into which the signals of the acceleration sensors 4a to 4f have been input. More specifically, a_{bx}, a_{ry}, a_{ly}, a_{rz}, a_{lz} and a_{bz} are the output values of the acceleration amplifier 14 corresponding to the acceleration sensors 4a to 4f. A_{G} is the accelerations of the gravity center in the axes and angular accelerations of the gravity center about the axes in the system that has six degrees of freedom and adopts the gravity center as the origin. More specifically, ax_{G}, ay_{G} and az_{G} are the respective accelerations in the X, Y and Z-axes directions, and aωx_{G}, aωy_{G} and aωz_{G} are the respective angular accelerations about the X, Y and Z-axes. Furthermore, the coefficients in a matrix T_{A} are determined according to the coordinates of the acceleration sensors 4a to 4f in the coordinate system that adopts the gravity center as the origin. More specifically, y_{Abx} and z_{Abx} are the respective Y and Z coordinate values of the acceleration sensor 4a. x_{Ary} and z_{Ary} are the respective X and Z coordinate values of the acceleration sensor 4b. x_{Aly} and z_{Aly} are the respective X and Z coordinate values of the acceleration sensor 4c. Furthermore, x_{Arz} and y_{Arz} are the respective X and Y coordinate values of the acceleration sensor 4d. x_{Alz} and y_{Alz} are the respective X and Y coordinate values of the acceleration sensor 4e. x_{Abz} and y_{Abz} are the respective X and Y coordinate values of the acceleration sensor 4f.

According to Expression (5), the accelerations of the gravity center in the axes and the angular accelerations of the gravity center about the axes in the system that has six degrees of freedom and adopts the gravity center as the origin are represented from the output values of the acceleration sensors 4a to 4f by the following Expression (6).

A_{G}=T_{A}⁻¹·A_{A} (6)

Here, a gravity center vibration coordinate transformation matrix T_{A}⁻¹ is represented. A gravity center vibration coordinate transformation operation unit 10 outputs a signal corresponding to a value acquired by multiplying values A_{A} corresponding to the acceleration sensors 4a to 4f input from the acceleration amplifier 14 by the gravity center vibration coordinate transformation matrix T_{A}⁻¹. That is, the gravity center vibration coordinate transformation operation unit 10 outputs signals corresponding to the accelerations of the gravity center in the axes and the angular accelerations of the gravity center about the axes A_{G} in the system that has six degrees of freedom and adopts the gravity center as the origin.

The accelerations of the gravity center in the axes and the angular accelerations of the gravity center about the axes in the system that has six degrees of freedom and adopts the gravity center as the origin that are output from the gravity center vibration coordinate transformation operation unit 10 are input into integrators 13a to 13f, converted into a velocity term and an angular velocity term, and output to the vibration control unit 11.

The vibration control unit 11 multiplies the values input from the integrators 13a to 13f by proportional gains, and further adds output results of floor acceleration feedforward to components in the translational directions in the X, Y and Z-axes. The thus acquired values are output, to the linear motor driving force distribution operation unit 12, for desired vibration control (i.e., for compensating the accelerations of the gravity center) in the axes in the system that has six degrees of freedom and adopts the gravity center as the origin.

A method of calculating an output result of floor acceleration feedforward will be described. As illustrated in FIG. 1, a floor acceleration sensor 4g detects an acceleration in the X direction on the floor. A floor acceleration sensor 4h detects an acceleration in the Y direction on the floor. A floor acceleration sensor 4i detects an acceleration in the Z direction on the floor. The output values of the floor acceleration sensors 4g to 4i are input into the acceleration amplifier 14. The output values of the acceleration amplifier 14 that correspond to the acceleration sensors 4g to 4i are represented as axf, ayf and azf, respectively. The output values axf, ayf and azf are input into second order integrators 13g, 13h and 13i, respectively, and converted into displacement terms, which are multiplied by proportional gains; the multiplied values are output as generation powers of the gravity center in the x, y and Z directions, to the vibration control unit 11. The thus acquired output results of the floor acceleration feedforward are used for compensating forces generated by the air springs owing to change in positions on the floor, with forces generated by the linear motors.

Linear motor driving force distribution operation unit 12 computes inputs required to appropriately operate the linear motors 5a to 5f, from the desired vibration control input from the vibration control unit 11 in the axes in the system that has six degrees of freedom and adopts the gravity center as the origin. The signals computed and output from the linear motor driving force distribution operation unit 12 are D/A-converted by D/A converters 16a to 16f and input into the linear motors 5a to 5f.

With respect to the output values of the linear motors 5a to 5f, the translational forces in the axes and the torques about the axes in the system that has six degrees of freedom and adopts the gravity center as the origin for compensating the accelerations of the gravity center are represented based on the positional relationship between the linear motors 5a to 5f by the following Expression (7).

$${F}_{GM} = {T}_{M} \cdot {F}_{M} \\ {F}_{GM} = [ \begin{matrix}{F}_{M x} \\ {F}_{My} \\ {F}_{Mz} \\ {T}_{M x} \\ {T}_{My} \\ {T}_{Mz}\end{matrix} ] , {F}_{M} = [ \begin{matrix}{F}_{Mbx} \\ {F}_{Mry} \\ {F}_{Mly} \\ {F}_{Mrz} \\ {F}_{Mlz} \\ {F}_{Mbz}\end{matrix} ] \\ {T}_{M} = [ \begin{matrix}1 & 0 & 0 & 0 & 0 & 0 \\ 0 & 1 & 1 & 0 & 0 & 0 \\ 0 & 0 & 0 & 1 & 1 & 1 \\ 0 & - {z}_{Mry} & - {z}_{Mly} & {y}_{Mrz} & {y}_{Mlz} & {y}_{Mbz} \\ {z}_{Mbx} & 0 & 0 & - {x}_{Mrz} & - {x}_{Mlz} & - {x}_{Mbz} \\ - {y}_{Mbx} & {x}_{Mry} & {x}_{Mly} & 0 & 0 & 0\end{matrix} ] \qquad ( 7 )$$

Here, F_{M} is output values of the linear motors 5a to 5f. More specifically, F_{Mbx}, F_{Mry}, F_{Mly}, F_{Mrz}, F_{Mlz} and F_{Mbz} are the respective output values of the linear motors 5a, 5b, 5c, 5d, 5e and 5f. F_{GM} is the translational forces in the axes and the torques about the axes in the system that has six degrees of freedom and adopts the gravity center as the origin. More specifically, F_{Mx}, F_{My} and F_{Mz} are the translational forces in the respective X, Y and Z-axes directions. T_{Mx}, T_{My} and T_{Mz} are the torques about the respective X, Y and Z-axes. The coefficients in a matrix T_{M} are determined according to the coordinates of the points of application of the linear motors 5a to 5f in the system that has six degrees of freedom and adopts the gravity center as the origin. More specifically, y_{Mbx} and z_{Mbx} are the respective Y and Z coordinate values of the points of application of the linear motor 5a. x_{Mry} and z_{Mry} are the respective X and Z coordinate values of the points of application of the linear motor 5b. x_{Mly} and z_{Mly} are the respective X and Z coordinate values of the points of application of the linear motor 5c. Furthermore, x_{Mrz} and y_{Mrz} are the respective X and Y coordinate values of the points of application of the linear motor 5d. x_{Mlz} and y_{Mlz} are the respective X and Y coordinate values of points of application of the linear motor 5e. x_{Mbz} and y_{Mbz} are the respective X and Y coordinate values of the points of application of the linear motor 5f.

According to Expression (7), conversion of inputs that is required to appropriately operate the linear motors 5a to 5f is represented based on the desired vibration control on the axes in the system that has six degrees of freedom and adopts the gravity center as the origin, by the following Expression (8).

F_{M}=T_{M}⁻¹·F_{G} (8)

Here, a linear motor driving force distribution matrix T_{M}⁻¹ is represented. The linear motor driving force distribution operation unit 12 outputs a value acquired by multiplying the output value F_{G} of the vibration control unit 11 having been input and the linear motor driving force distribution matrix T_{M}⁻¹ together, that is, the input F_{M} required for the linear motors 5a to 5f with respect to control forces in the axes in the system that has six degrees of freedom and adopts the gravity center as the origin.

Thus, the active anti-vibration apparatus 50 can be supplied with damping by adding the vibration control loop 19. An advantageous effect of improving the anti-vibration performance of the anti-vibration table can be exerted. Here, for simplifying of the mathematical expressions, the configuration in the system that has six degrees of freedom and adopts the gravity center as the origin is described. However, the coordinate system may adopt any point as the origin. Instead, the configuration can be achieved in a system with three degrees of freedom.

In this embodiment, linear motors (actuators) are adopted for compensating the accelerations. However, the actuators are not limited thereto.

FIG. 2B is a block diagram illustrating in detail the vibration control loop 19 of the active anti-vibration apparatus 50 in this embodiment.

The outputs of the acceleration sensors 4a to 4i used in this embodiment are, for instance, analog outputs. The wide range of vibrations from normally occurring micro vibrations to a relatively large vibrations caused by an earthquake can be detected. An offset voltage sometimes occurs in an output signal. The offset voltage is caused not only by adverse effects of individual differences of components configuring the acceleration sensors and variation in temperature but also by sensor arrangement angles.

The acceleration amplifier 14 adopted in this embodiment includes a DC offset elimination circuit 14a, and an acceleration detection gain 14b.

The DC offset elimination circuit 14a functions so as to compensate (cancel) the offset voltages of the acceleration sensors 4a to 4i, extract only the vibration components, and perform measurement utilizing the dynamic range of the A/D converter. Thus, the DC offset elimination circuit 14a is a high-pass filter, which normally passes high frequency components. To improve the anti-vibration performance for a low frequency region, the DC offset elimination circuit 14a is configured such that the cutoff frequency is set low to widen the passing band of the filter. For instance, the cutoff frequency is set to 0.1 Hz or less.

The acceleration detection gain 14b has a function of amplifying analog acceleration signals output from the acceleration sensors 4a to 4i. To exhibit an anti-vibration performance at normal times at the maximum, the acceleration detection gain 14b is increased to a level such that the acceleration signals of the acceleration sensors 4a to 4i in a normal state can be sufficiently detected as signals by respective A/D converters 15a to 15i. The A/D converters 15a to 15i A/D-convert the signal output from the acceleration detection gain 14b and output the signal.

An operation of active anti-vibration apparatus 50 of this embodiment in abnormality, for instance, in the case of occurrence of an excessive acceleration due to occurrence of one of an earthquake and a setup operation on a mounted device will be described.

When strong vibrations are applied to the active anti-vibration apparatus 50 of this embodiment, the anti-vibration table 1 may be significantly inclined and excessive accelerations may occur in the acceleration sensors 4a to 4f.

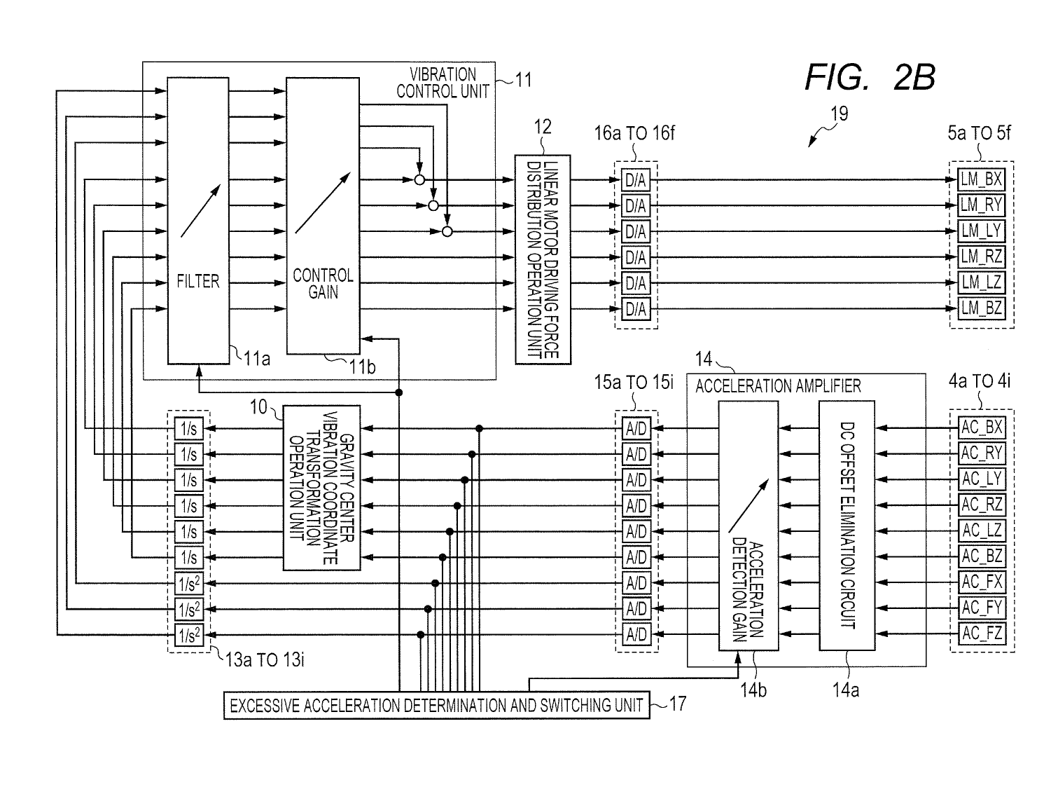

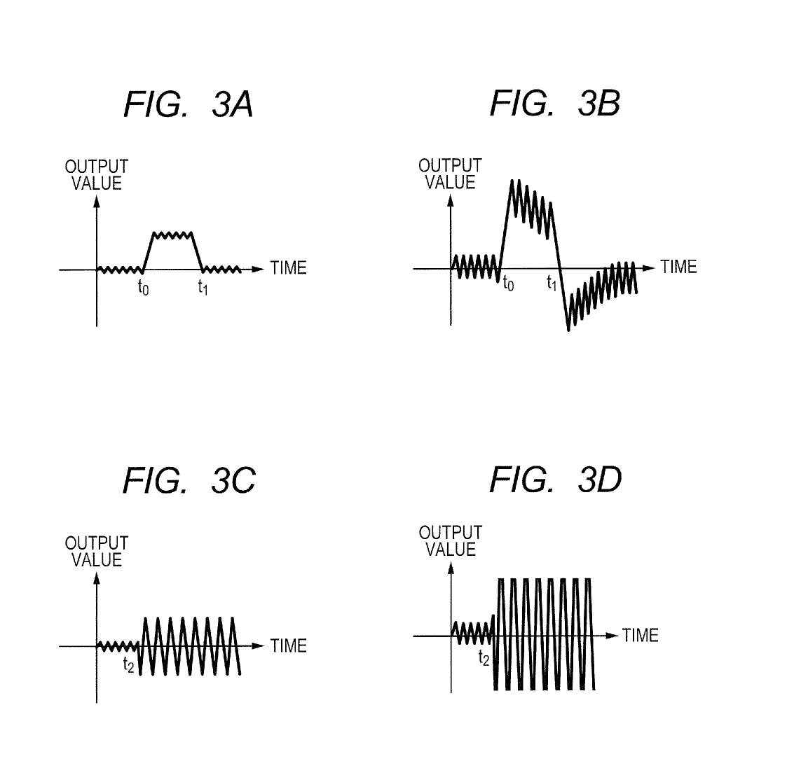

FIGS. 3A and 3B schematically illustrate the temporal variations of output values of the acceleration sensors 4a to 4f and the acceleration amplifier 14, respectively, when the anti-vibration table 1 is temporarily inclined, for instance, when a heavy workpiece is mounted in a setup.

In such a case, angular variations occur in the acceleration sensors 4a to 4f. The variations cause offsets in the output values of the acceleration sensors 4a to 4f temporarily, that is, offsets occur in a period from time t₀ to t₁.

Meanwhile, the output value of the acceleration amplifier 14 varies such that an operation of the DC offset elimination circuit 14a gradually returns the output value with abrupt variation to 0. This operation causes transient signal variation.

If the state where the output value of the acceleration amplifier 14 does not return to 0 continues, the anti-vibration apparatus 50 may oscillate.

For instance, if an angular variation occurs in the acceleration sensor 4a for detecting the acceleration in the X direction, a current instruction value for driving the linear motor 5a in the same direction continues to be output through the gravity center vibration coordinate transformation operation unit 10, the integrator 13a, the vibration control unit 11 and the linear motor driving force distribution operation unit 12. Then, the vibration control in the X direction of the anti-vibration apparatus 50 does not function. The position control loop 18 oscillates and, resultantly, the anti-vibration table 1 oscillates.

FIGS. 3C and 3D schematically illustrate the temporal variations of the output values of the acceleration sensors 4a to 4f and the acceleration amplifier 14, respectively, when excessive accelerations, such as for instance of an earthquake, occurs in the acceleration sensors 4a to 4f.

In such a case, as a result that the acceleration detection gain 14b amplifies the signals output from the acceleration sensors 4a to 4f, the signals exceed a voltage range where the acceleration amplifier 14 can output signals, and the output of the acceleration amplifier 14 is saturated. If the output of the acceleration amplifier 14 is saturated, the anti-vibration performance of the anti-vibration apparatus 50 is reduced.

For instance, if an excessive acceleration occurs in the acceleration sensor 4a for detecting an acceleration in the X direction, the signals to the linear motor 5a is saturated through the gravity center vibration coordinate transformation operation unit 10, the integrator 13a, the vibration control unit 11 and the linear motor driving force distribution operation unit 12. Accordingly, as illustrated in FIG. 3D, the waveform is cut off in proximity to the maximum values and the minimum values. As a result, the control on the anti-vibration apparatus 50 in the X direction does not ideally function, and the anti-vibration performance of the anti-vibration apparatus 50 is reduced.

Thus, in the active anti-vibration apparatus 50 of this embodiment, the acceleration detection gain 14b of the acceleration amplifier 14 is variable. Furthermore, a high-pass filter 11a is provided in the vibration control unit 11 to allow the filter time constant to be variable. The vibration control unit 11 is further provided with an acceleration control gain 11b to allow the gain to be variable. Moreover, an excessive acceleration determination and switching unit (determination unit) 17 is provided, and an excessive acceleration is determined using A/D-converted values of the acceleration sensors 4a to 4i output from the acceleration amplifier 14. Signals for switching the acceleration detection gain 14b and the time constant of the filter 11a of the vibration control unit 11 are then output.

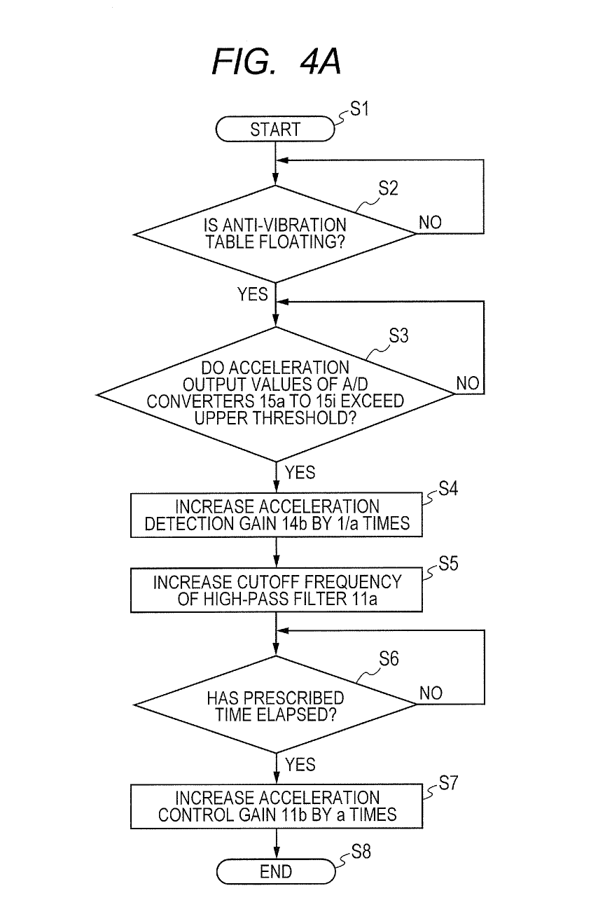

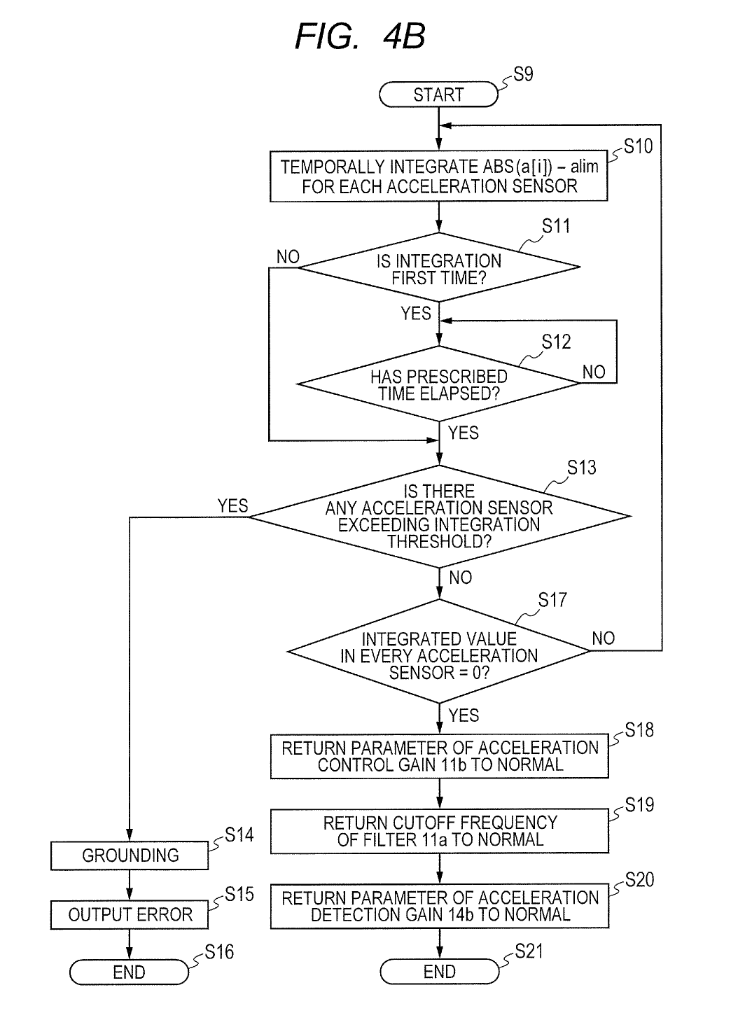

FIG. 4A is a flowchart illustrating a process upon occurrence of an excessive acceleration in the active anti-vibration apparatus 50 according to this embodiment. After the anti-vibration apparatus 50 floats and comes into a stable state (Yes in S2), it is monitored whether any of the output values of the A/D converters 15a to 15i exceeds an upper threshold or not (S3).

If any of the output values of the A/D converters 15a to 15i exceeds the upper threshold owing to occurrence of the excessive acceleration (Yes in S3), first, the acceleration detection gain 14b is increased by 1/a times (S4). The cutoff frequency of the high-pass filter 11a, which passes signals with at least the cutoff frequency, is increased by a prescribed frequency (S5). Here, 1/a is a prescribed magnification having been predetermined. After a prescribed time has elapsed (Yes in S6), the acceleration control gain 11b is multiplied by the reciprocal of the prescribed magnification, that is, increased by “a” times (S7), and the process is finished (S8).

If the excessive acceleration thus occurs (i.e., if the acceleration of the gravity center becomes at least a prescribed acceleration), the setting values for the acceleration detection gain 14b, the high-pass filter 11a and the acceleration control gain 11b are switched as described above. In the switched state, the detection resolution of the signal output from the acceleration amplifier 14 is reduced. Accordingly, the anti-vibration performance of the anti-vibration apparatus 50 against micro vibrations is reduced. However, the loop gain for a vibration control system is maintained. Accordingly, the anti-vibration performance against a relatively strong vibrations is equivalent to the anti-vibration performance against micro vibrations at normal times (i.e., in the case without occurrence of an excessive acceleration). The acceleration control gain 11b is thus increased after the characteristics of the acceleration detection gain 14b is changed to prevent the anti-vibration apparatus 50 from oscillating by preliminarily increasing the acceleration control gain 11b to increase the entire gain of the vibration control loop 19.

It is defined that, at normal times (without occurrence of an excessive acceleration), the acceleration detection gain 14b is Kamp, the acceleration control gain 11b is Kvb, gains upon occurrence of the excessive acceleration are Kamp′ and Kvb′. The relationship therebetween is represented by the following Expression (9).

$${Kamp}^{′} = ( 1 / a ) ⋆ Kamp , {Kvb}^{′} = a ⋆ Kvb \\ Kamp = [ \begin{matrix}kMamp \\ kMamp \\ kMamp \\ kMamp \\ kMamp \\ \begin{matrix}kMamp \\ kFamp \\ kFamp \\ kFamp\end{matrix}\end{matrix} ] , Kvb = [ \begin{matrix}kx \\ ky \\ kz \\ k ω x \\ k ω y \\ k ω z \\ kFx \\ kFy \\ kFz\end{matrix} ] \qquad ( 9 )$$

Here, kMamp is the acceleration detection gains for the signals of the acceleration sensors 4a to 4f. kFamp is the acceleration detection gains for the signals of the floor acceleration sensors 4g to 4i. kx, ky and kz are the control gains of the gravity center in the respective translational directions. kωx, kωy and kωz are control gains in the respective rotational directions of the gravity center. kFx, kFy and kFz are the control gains for floor acceleration feedforward.

As represented by Expression (9), the A/D-converted input values of the floor acceleration sensors 4g to 4i are also included in determination conditions for occurrence of an excessive acceleration. This is because, if the floor acceleration is excessive, occurrence of an earthquake is assumed, and, even in the case where the acceleration input values for the acceleration sensors 4a to 4f do not exceed the upper threshold, it is difficult to continue to maintain the anti-vibration performance at normal times in the anti-vibration apparatus 50. Note that the A/D-converted input values of the floor acceleration sensors 4g to 4i are not necessarily included in the determination conditions.

In this embodiment, two sets of setting values for each of the acceleration detection gain 14b, the high-pass filter 11a, the filter time constant, and the acceleration control gain 11b are provided for the respective two cases, which are the case without occurrence of an excessive acceleration and the case with occurrence of an excessive acceleration. These setting values are switched upon occurrence of an excessive acceleration. Instead, the anti-vibration apparatus 50 may be configured such that at least three sets of setting values for the acceleration detection gain 14b, the high-pass filter 11a, the filter time constant, and the control gain 11b may be provided, and the values are switched gradually according to the magnitude of the acceleration.

In this embodiment, every acceleration detection gain for the signals of the acceleration sensors 4a to 4f is kMamp. Every acceleration detection gain for the signals of the floor acceleration sensors 4g to 4i is kFamp. That is, irrespective of the detection direction, the same gain is adopted for all the x, y and Z directions. However, in the case where it is intended that the vibration levels are different in the detection directions, and each vibration level is detected at an optimal high resolution, the acceleration detection gain may be changed according to the detection direction.

The comparison between the acceleration output value and the upper threshold in step S3 in FIG. 4A may be performed using a vibration prediction signal, such as an earthquake alert, instead of the acceleration signals of the acceleration sensors provided in the anti-vibration apparatus 50.

Furthermore, in this embodiment, in addition to the DC offset elimination circuit 14a in the acceleration amplifier 14, the high-pass filter 11a capable of changing the cutoff frequency (filter time constant) is provided in the vibration control unit 11. Accordingly, switching of the time constant upon occurrence of an excessive acceleration prevents a transient response from being output to the linear motors 5a to 5f. Instead, the time constant of the DC offset elimination circuit 14a itself may be variable to avoid a phenomenon of occurrence of a transient response.

The process upon occurrence of an excessive acceleration in the active anti-vibration apparatus 50 according to this embodiment has been described above. More specifically, switching of the setting values of the acceleration detection gain 14b, the high-pass filter 11a and the acceleration control gain 11b upon occurrence of an excessive acceleration has been described.

Next, a mode will be described where the state of the acceleration output value is determined after the switching, and the anti-vibration apparatus 50 transitions to an appropriate state according to the determination.

More specifically, in the thus switched state, the anti-vibration performance of the anti-vibration apparatus 50 against micro vibrations is reduced. Accordingly, if the accelerations detected by the acceleration sensors 4a to 4i return to normal levels, the anti-vibration apparatus 50 returns to a normal control state. Meanwhile, if the state of detecting an excessive acceleration has still continued, the anti-vibration apparatus 50 is required to transition to a grounded state in view of protecting the anti-vibration apparatus 50 and the mounted device.

FIG. 4B is a flowchart illustrating a process after switching of each setting value upon occurrence of an excessive acceleration in the active anti-vibration apparatus 50 of this embodiment.

First, the acceleration output value of each acceleration sensor is compared with an acceleration threshold. More specifically, this process is performed according to the following Expression (10).

$$a\_int err [ i ] = {\sum }_{t = 0}^{T} ( ABS ( a [ i ] ) - a lim ) \\ a\_int err [ i ] < 0 -> a\_int err [ i ] = 0 \qquad ( 10 )$$

Here, a[i] (i=1 to 9) are A/D input values of the six acceleration sensors 4a to 4f and the three floor acceleration sensors 4g to 4i. alim is the acceleration threshold for each acceleration sensor. After switching of each setting value accompanying occurrence of the excessive acceleration, the difference between the absolute value ABS(a[i]) of a[i] of each acceleration sensor and the acceleration threshold alim is temporally integrated for a prescribed time, and the acquired integrated result for each acceleration sensor is adopted as a_interr[i] (S10). If the acceleration integrated value a_interr[i] is negative, a_interr[i] is set to 0.

Next, the temporal integration in step S10 is at the first time (Yes in S11), elapse of a prescribed time is waited for (S12). After elapse of the prescribed time (Yes in S12), the acceleration integrated value a_interr[i] is compared with the acceleration integration threshold alim_interr for each acceleration sensor (S13). If no acceleration sensor has the acceleration integrated value a_interr[i] exceeding the acceleration integration threshold alim_interr (No in S13), it is subsequently checked whether or not the acceleration integrated value a_interr[i] is equal to or less than a prescribed integrated value for each acceleration sensor (S17). If the acceleration integrated value a_interr[i] of any acceleration sensor is not equal to or less than the prescribed integrated value (No in S17), the processing returns to S10 and temporal integration is newly performed for a prescribed time. Subsequently, the integration is at the second time or later (No in S11). Accordingly, there is no need to wait for a prescribed time in step S12. The desired value less than or equal to the prescribed integrated value may be 0.

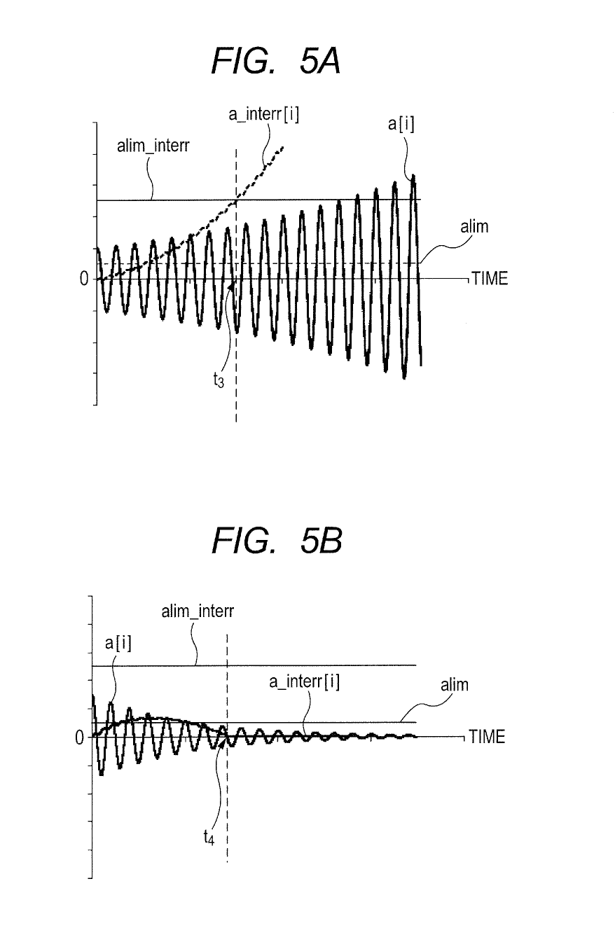

FIG. 5A illustrates behavior of the acceleration a[i] during continuation of detecting an excessive acceleration for i-th acceleration sensor after switching each setting value upon occurrence of the excessive acceleration.

As illustrated in FIG. 5A, after switching of each setting value upon occurrence of the excessive acceleration (time t=0), the acceleration a[i] has still been increasing. In this case, between time t=0 and t₃, the acceleration integrated value a_interr[i] does not exceed the alim_interr while not being 0. Accordingly, in the flowchart of FIG. 4B, steps S10→S13→S17→S10 are repeated. Since at time t=t₃, the acceleration integrated value a_interr[i] exceeds the alim_interr (Yes in S13), the processing proceeds from S13 to S14. At this time, in view of protecting the anti-vibration apparatus 50 and the mounted device, the anti-vibration apparatus 50 is grounded (S14), an error is output (S15) and the process is finished (S16).

FIG. 5B illustrates behavior of the acceleration a[i] in the case of decrease in the excessive acceleration for the i-th acceleration sensor after switching of each setting value upon occurrence of the excessive acceleration.

As illustrated in FIG. 5B, after switching of each setting value upon occurrence of the excessive acceleration (time t=0), the acceleration integrated value a_interr[i] temporarily increases and subsequently starts to decrease. As with FIG. 5A, between time t=0 and t₄, the acceleration integrated value a_interr[i] does not exceed the alim_interr, while not being 0. Accordingly, in the flowchart of FIG. 4B, steps S10→S13→S17→S10 are repeated. At time t=t₄, the acceleration integrated value a_interr[i] reaches 0. Although not illustrated, provided that the acceleration integrated value a_interr[i] reaches 0 at time t=t₄ for all the other acceleration sensors (Yes in S17), the processing proceeds from S17 to S18. At this time, the parameter of the acceleration control gain 11b is returned to the normal parameter (i.e., the gain is increased by 1/a times, S18), and the cutoff frequency of the high-pass filter 11a is returned to the original value (S19). The parameter of the acceleration detection gain 14b is then returned to the normal parameter (i.e., the gain is increased by “a” times, S20), and the process is finished (S21).

As described above, the process has been described that determines the behavior of the acceleration after switching of each setting value upon occurrence of the excessive acceleration, and causes the anti-vibration apparatus 50 to transition to one of the original control state without occurrence of an excessive acceleration and the grounded state based on the determination result. In this embodiment, the same acceleration threshold alim and acceleration integration threshold alim_interr are set to the acceleration sensors 4a to 4f and the floor acceleration sensors 4g to 4i. Instead, different thresholds may be provided for respective acceleration sensors, and the determination may be performed.

As described above, for simplifying of the mathematical expressions, the configuration in the system that has six degrees of freedom and adopts the gravity center as the origin has been described. However, the configuration can be achieved in a system with three degrees of freedom instead.

For instance, a control system may be adopted that has vertical three degrees of freedom and adopts the gravity center as the origin without the displacement sensors and the actuators in the horizontal direction.

The differences from the configuration of the system with six degrees of freedom will be mainly described in brief.

With respect to the displacement in the Z direction at the gravity center and the rotational amounts about the X and the Y-axes at the gravity center in the system that has vertical three degrees of freedom and adopts the gravity center as the origin, the outputs of the displacement sensors 3d to 3f are represented from the positional relationship therebetween by the following Expression (11).

$${P}_{P} = {T}_{P} \cdot {P}_{G} \\ {P}_{P} = [ \begin{matrix}{p}_{rz} \\ {p}_{lz} \\ {p}_{bz}\end{matrix} ] , {P}_{G} = [ \begin{matrix}{pz}_{G} \\ p ω {x}_{G} \\ p ω {y}_{G}\end{matrix} ] \\ {T}_{P} = [ \begin{matrix}1 & {y}_{Prz} & - {x}_{Prz} \\ 1 & {y}_{Plz} & - {x}_{Plz} \\ 1 & {y}_{Pbz} & - {x}_{Pbz}\end{matrix} ] \qquad ( 11 )$$

As with the case of the configuration with the system with six degrees of freedom, the expression for acquiring the displacements and the rotational amounts at the gravity center from the values of the displacement sensors is represented as Expression (2).

The gravity center displacement coordinate transformation operation unit 7 receives outputs P_{P} of the displacement sensors 3d to 3f as inputs, and outputs values acquired by multiplying the inputs by the gravity center displacement coordinate transformation matrix T_{P}⁻¹, that is, the displacements in the Z direction at the gravity center in the system that has vertical three degrees of freedom and adopts the gravity center as the origin, and the rotational amounts at the gravity center about the X and Y-axes.

The linear motor driving force distribution operation unit 12 computes inputs required for the linear motors 5d to 5f, based on the values in the X, Y and Z-axes at the gravity center that are output from the vibration control unit 11 in the system that has vertical three degrees of freedom and adopts the gravity center as the origin. With respect to the outputs of the linear motors 5d to 5f, the translational force at the gravity center in the Z direction and the torques at the gravity center about the X and Y-axes in the system that has vertical three degrees of freedom and adopts the gravity center as the origin are represented from the positional relationship therebetween by the following Expression (12).

$${F}_{GM} = {T}_{M} \cdot {F}_{M} \\ {F}_{GM} = [ \begin{matrix}{F}_{Mz} \\ {T}_{M x} \\ {T}_{My}\end{matrix} ] , {F}_{M} = [ \begin{matrix}{F}_{Mrz} \\ {F}_{Mlz} \\ {F}_{Mbz}\end{matrix} ] \\ {T}_{M} = [ \begin{matrix}1 & 1 & 1 \\ {y}_{Mrz} & {y}_{Mlz} & {y}_{Mbz} \\ - {x}_{Mrz} & - {x}_{Mlz} & - {x}_{Mbz}\end{matrix} ] \qquad ( 12 )$$

As with the configuration of the system with six degrees of freedom, the values in the X, Y and Z-axes at the gravity center that are output from the vibration control unit 11 in the system that has vertical three degrees of freedom and adopts the gravity center as the origin are converted into inputs required for the linear motors 5d to 5f by the linear motor driving force distribution operation unit 12 according to Expression (8).

Thus, adoption of the configuration of the system that has vertical three degrees of freedom and adopts the gravity center as the origin contributes to reduction in cost by reducing the numbers of displacement sensors and linear motors.

Likewise, a control system with horizontal three degrees of freedom can be configured. More specifically, this system can be easily configured by removing the air spring actuators and acceleration sensors in the vertical direction.

With respect to the displacements at the gravity center in the X and Y-axes and the rotational amount at the gravity center about the Z-axis in the system that has horizontal three degrees of freedom and adopts the gravity center as the origin, the outputs of the displacement sensors 3a to 3c are represented from the positional relationship therebetween by the following Expression (13).

$${P}_{P} = {T}_{P} \cdot {P}_{G} \\ {P}_{P} = [ \begin{matrix}{p}_{bx} \\ {p}_{ry} \\ {p}_{ly}\end{matrix} ] , {P}_{G} = [ \begin{matrix}{px}_{G} \\ {py}_{G} \\ {pz}_{G}\end{matrix} ] \\ {T}_{P} = [ \begin{matrix}1 & 0 & - {y}_{Pbx} \\ 0 & 1 & {x}_{Pry} \\ 0 & 1 & {x}_{Ply}\end{matrix} ] \qquad ( 13 )$$

As with the configuration of the system with six degrees of freedom, the expression for acquiring the displacements and the rotational amounts at the gravity center from the values of the displacement sensors is represented by Expression (2).

The gravity center displacement coordinate transformation operation unit 7 receives the outputs P_{P} of the displacement sensors 3a to 3c as inputs, and outputs the values acquired by multiplying the inputs by the gravity center displacement coordinate transformation matrix T_{P}⁻¹, that is, the displacements in the X and Y-axes at the gravity center and the rotational amount at the gravity center about the Z-axis in the system that has horizontal three degrees of freedom and adopts the gravity center as the origin.

The linear motor driving force distribution operation unit 12 computes inputs required for the linear motors 5a to 5c, based on the values at the gravity center in the X, Y and Z-axes that are output from the vibration control unit 11 in the system that has horizontal three degrees of freedom and adopts the gravity center as the origin. With respect to the outputs of the linear motors 5a to 5c, the translational forces at the gravity center in the X and Y-axes directions and the torques at the gravity center about the Z-axis in the system that has horizontal three degrees of freedom and adopts the gravity center as the origin are represented from the positional relationship therebetween by the following Expression (14).

$${F}_{GM} = {T}_{M} \cdot {F}_{M} \\ {F}_{GM} = [ \begin{matrix}{F}_{M x} \\ {T}_{My} \\ {T}_{Mz}\end{matrix} ] , {F}_{M} = [ \begin{matrix}{F}_{Mbx} \\ {F}_{Mry} \\ {F}_{Mly}\end{matrix} ] \\ {T}_{M} = [ \begin{matrix}1 & 0 & 0 \\ 0 & 1 & 1 \\ - {y}_{Mbx} & {x}_{Mry} & {x}_{Mly}\end{matrix} ] \qquad ( 14 )$$

As with the configuration of the system with six degrees of freedom, the values at the gravity center in the X, Y and Z-axes that are output from the vibration control unit 11 in the system that has horizontal three degrees of freedom and adopts the gravity center as the origin are converted into inputs required for the linear motors 5a to 5c by the linear motor driving force distribution operation unit 12 according to Expression (8).

The configurations in the system that has vertical three degrees of freedom and adopts the gravity center as the origin and in the system that has horizontal three degrees of freedom and adopts the gravity center as the origin have thus been described. Instead, also in the case of another degrees of freedom, the system can be easily achieved by changing the matrix expression according to the degrees of freedom.

Furthermore, provided that the coordinates in the expressions are represented as relative coordinates with reference to the gravity center, the configuration can be achieved also in a coordinate system that adopts any point as the origin.

In the case of adopting the coordinate system that adopts any point as the origin, specifically, provided that the X, Y and Z coordinates at the gravity center are x_{G}, y_{G} and z_{G}, in the expression,
x_{Pry} may be replaced with (x_{Pry}−x_{G}),
x_{Prz} may be replaced with (x_{Prz}−x_{G}),
x_{Ply} may be replaced with (x_{Ply}−x_{G}),
x_{Plz} may be replaced with (x_{Plz}−x_{G}),
x_{Pbz} may be replaced with (x_{Pbz}−x_{G}),
y_{Prz} may be replaced with (y^{Prz}−y_{G}),
y_{Plz} may be replaced with (y_{Plz}−y_{G}),
y_{Pbx} may be replaced with (y_{Pbx}−y_{G}),
y_{Pbz} may be replaced with (y_{Pbz}−y_{G}),
z_{Pry} may be replaced with (z_{Pry}−z_{G}),
z_{Ply} may be replaced with (z_{Ply}−z_{G}), and
z_{Pby} may be replaced with (z_{Pby}−z_{G});
x_{Mry} may be replaced with (x_{Mry}−x_{G}),
x_{Mly} may be replaced with (x_{Mly}−x_{G}),
x_{Mrz} may be replaced with (x_{Mrz}−x_{G}),
x_{Mlz} may be replaced with (x_{Mlz}−x_{G}),
x_{Mbz} may be replaced with (x_{Mbz}−x_{G}),
y_{Mrz} may be replaced with (y_{Mrz}−y_{G}),
y_{Mlz} may be replaced with (y_{Mlz}−y_{G}).
y_{Mbx} may be replaced with (y_{Mbx}−y_{G}).
y_{Mbz} may be replaced with (y_{Mbz}−y_{G}).
z_{Mry} may be replaced with (z_{Mry}−z_{G}),
z_{Mly} may be replaced with (z_{Mly}−z_{G}), and
z_{Mbx} may be replaced with (z_{Mbx}−z_{G});
Moreover, xᵢ may be replaced with (xᵢ−x_{G}),
yᵢ may be replaced with (yᵢ−y_{G}), and
zᵢ may be replaced with (zᵢ−z_{G});
x_{Sry} may be replaced with (x_{Sry}−x_{G}),
x_{Srz} may be replaced with (x_{Srz}−x_{G}),
x_{Sry} may be replaced with (x_{Sry}−x_{G}),
x_{Slz} may be replaced with (x_{Slz}−x_{G}),
x_{Sbz} may be replaced with (x_{Sbz}−x_{G}),
y_{Srz} may be replaced with (y_{Srz}−y_{G}),
y_{Slz} may be replaced with (y_{Slz}−y_{G}),
y_{Sbx} may be replaced with (y_{Sbx}−y_{G}),
y_{Sbz} may be replaced with (y_{Sbz}−y_{G}),
z_{Sry} may be replaced with (z_{Sry}−z_{G}),
z_{Sry} may be replaced with (z_{Sry}−z_{G}), and
z_{Sbx} may be replaced with (z_{Sbx}−z_{G}); and
x_{Ary} may be replaced with (x_{Ary}−x_{G}),
x_{Arz} may be replaced with (x_{Arz}−x_{G}),
x_{Aly} may be replaced with (x_{Aly}−x_{G})
x_{Alz} may be replaced with (x_{Alz}−x_{G}),
x_{Abz} may be replaced with (x_{Abz}−x_{G}),
y_{Arz} may be replaced with (y_{Arz}−y_{G}),
y_{Alz} may be replaced with (y_{Alz}−y_{G}),
y_{Abx} may be replaced with (y_{Abx}−y_{G}),
y_{Abz} may be replaced with (y_{Abz}−y_{G}),
z_{Ary} may be replaced with (z_{Ary}−z_{G}),
z_{Aly} may be replaced with (z_{Aly}−z_{G}), and
z_{Abx} may be replaced with (z_{Abx}−z_{G}).

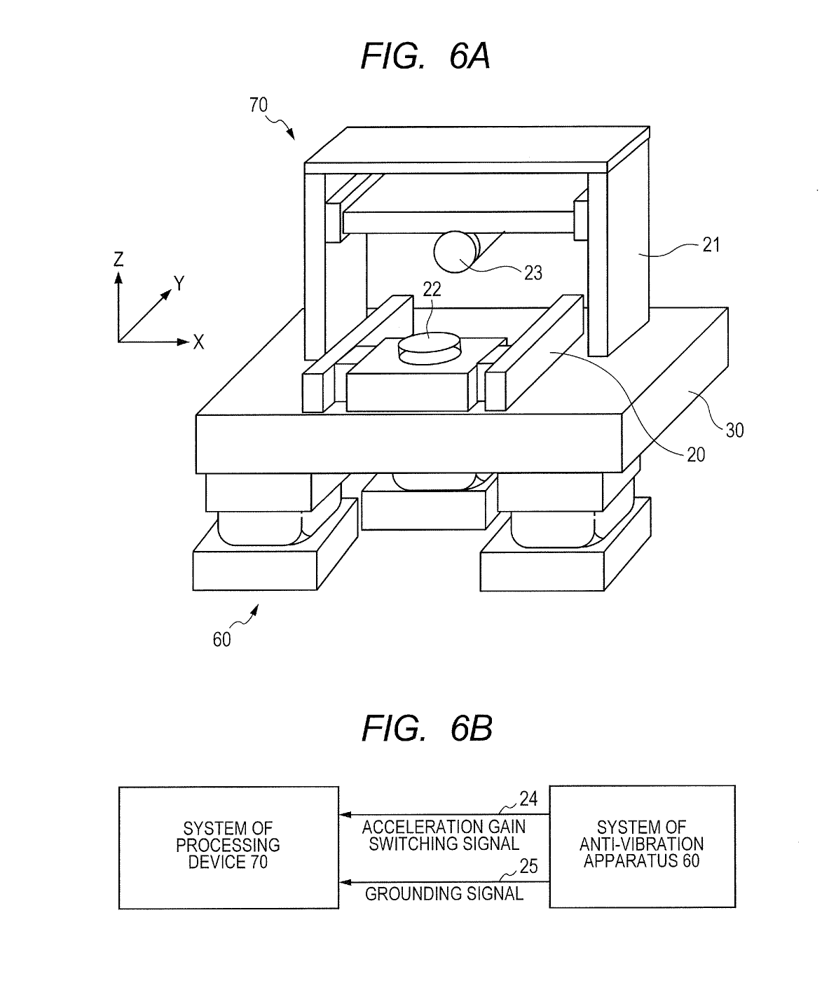

Next, a workpiece manufacturing method will be described where a device is mounted on the anti-vibration table of the active anti-vibration apparatus to which the this embodiment is applied, and a workpiece is manufactured by the mounted device. FIG. 6A illustrates an example where a processing device 70 is mounted on an active anti-vibration apparatus 60 to which this embodiment is applied. The anti-vibration table 1 of the anti-vibration apparatus 50 has a trapezoidal shape. Instead, the anti-vibration table 30 of the anti-vibration apparatus 60 has a rectangular shape. There is no difference in other configurational elements between the anti-vibration apparatus 60 and the anti-vibration apparatus 50. A processing device 70 includes a straight moving stage 20 movable in the X and Y directions, and a straight moving stage 21 movable in the Z direction. The processing device 70 further includes a rotational stage 22 mounted on the straight moving stage 20, and a rotational stage 23 mounted on the straight moving stage 21. In the processing device 70, a processing target (not illustrated) as an object is mounted on the rotational stage 22, and a tool (not illustrated) is mounted on the rotational stage 23. The processing target is processed by the tool while the stages move in synchronization.

FIG. 6B illustrates a block diagram on signal transmission and reception between the system of the processing device 70 and the system of the anti-vibration apparatus 60. The system of the anti-vibration apparatus 60 transmits, to the system of the processing device 70, status signals representing the state of the anti-vibration apparatus 60, such as an acceleration gain switching signal 24 and a grounding signal 25. The system of the processing device 70 receives these status signals, and performs a process according to the received signal.

If an excessive acceleration occurs in processing of the processing target in the processing device 70 and the processing surface of the processing target is affected by the excessive acceleration and the excessive vibrations, even reprocessing of the processing surface cannot finish the target as a good piece in many cases. Thus, the anti-vibration apparatus according to this embodiment and the processing device may be mounted on the processing experimental machine, to thereby allow logging the status signal from the anti-vibration apparatus and monitoring and determining the processing procedures by the processing device.

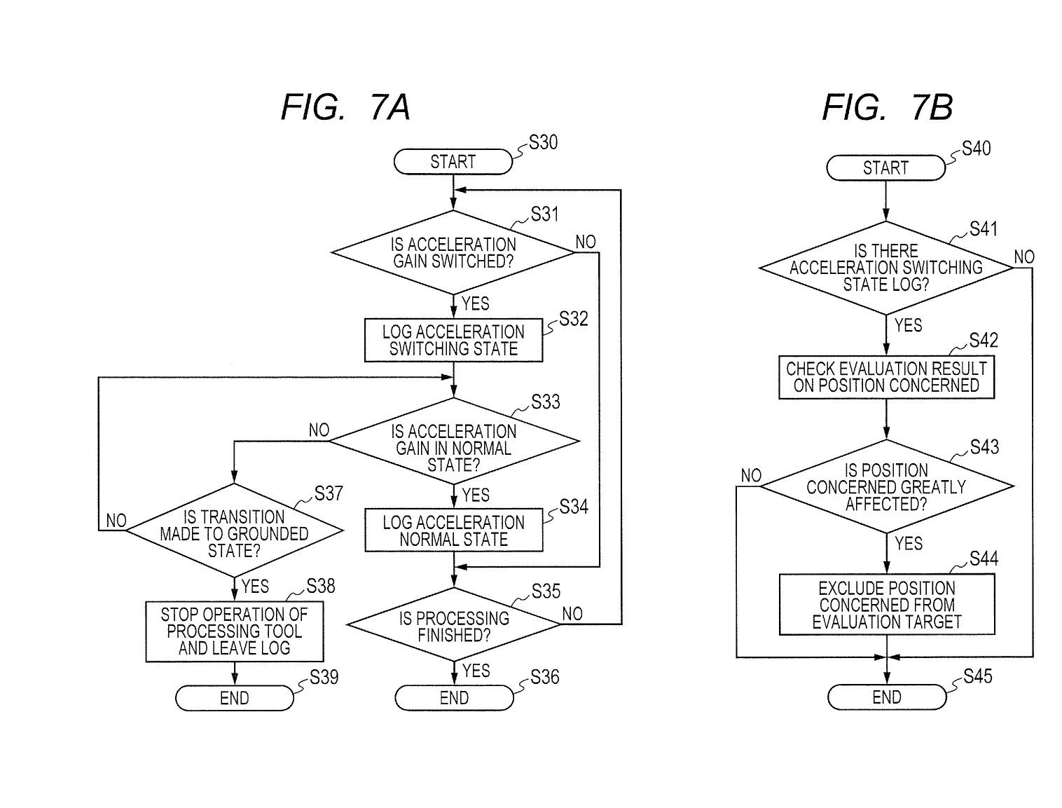

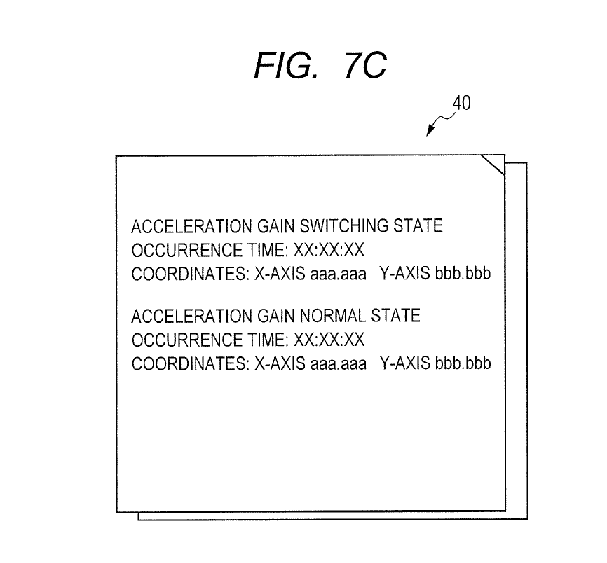

FIG. 7A illustrates a flowchart corresponding to monitoring of the processing procedures by the processing device in the processing experimental machine. First, after monitoring of the processing procedures is started (S30), it is checked whether the setting value for each configurational element, such as the acceleration gain due to occurrence of an excessive acceleration of the anti-vibration apparatus, is switched or not (S31). If the setting value has been switched (Yes in S31), the state of the processing procedures is stored in a log file 40 (see FIG. 7C) (S32). It is then checked whether the excessive acceleration is not detected and the setting value of each configurational element, such as the acceleration gain of the anti-vibration apparatus, is returned to the setting value at normal times (i.e., in the case without occurrence of an excessive acceleration) or not (S33). If it is verified that the setting value is returned to the setting value at normal times (Yes in S33), the state of the processing procedures is stored in the log file 40 (S34). Subsequently, it is checked whether the processing procedures is finished or not (S35). If the processing procedures is finished (Yes in S35), the monitoring process is finished (S36). If the processing procedures is not finished (No in S35), the processing returns to step S31, and the monitoring process is continued. Meanwhile, it is checked whether the setting value is returned to the setting value at normal times or not (S33). If the setting value is not returned to the setting value at normal times (No in S33), it is then checked whether the anti-vibration apparatus transitions to the grounded state due to continuation of the excessive acceleration (S37). If the anti-vibration apparatus transitions to the grounded state (Yes in S37), the operation of the processing tool is stopped, the state of the processing procedures is stored in the log file 40 (S38), and the monitoring process is finished (S39). If the anti-vibration apparatus does not transition to the grounded state (No in S37), the processing returns to step S33, and it is checked again whether the setting value is returned to the setting value at normal times or not. In step S31, it is checked the setting value of each configurational element, such as the acceleration gain of the anti-vibration apparatus due to occurrence of the excessive acceleration, is switched or not. If switching is not performed (No in S31), the processing proceeds to step S35, and it is checked whether the processing procedures are finished or not. If the processing procedures is completed (Yes in S35), the monitoring process is finished (S36). If the processing procedures is not completed (No in S35), the processing returns to step S31, and the monitoring process is continued.

FIG. 7B illustrates a flowchart corresponding to an evaluation on a result after the processing procedures by the processing device in the processing experimental machine. After the evaluation on the processing procedures is started (S40), it is checked whether a log is in the log file 40 or not (S41). If no log exists (No in S41), the evaluation process is finished (S45). If it is verified that a log is in the log file 40 (Yes in S41), the evaluation result at a position concerned, that is, a processing position of the processing target upon switching of the setting value of each configurational element of the anti-vibration apparatus due to occurrence of the excessive acceleration is checked based on the log (S42). If the position concerned is greatly affected by the excessive acceleration and the excessive vibrations (Yes in S43), the position concerned is excluded from the evaluation target (S44) and the evaluation process is finished (S45). In contrast, if the position concerned is not greatly affected by the excessive acceleration and the excessive vibrations (No in S43), the position concerned is not excluded from the evaluation target and the evaluation process is finished (S45).

FIG. 7C is a diagram specifically illustrating the log file 40. The log file 40 records the occurrence time and the coordinates of the processing position of the processing target at the time upon switching of the setting value of each configurational element, such as the acceleration gain of the anti-vibration apparatus due to occurrence of the excessive acceleration in switching (acceleration gain switching state). The log file 40 also records the occurrence time and the coordinates of the processing position of the processing target at the time upon returning of the setting value of each configurational element to the setting value at normal times (i.e., in the case without occurrence of an excessive acceleration) (acceleration gain normal state) due to detection of no excessive acceleration. When the anti-vibration apparatus transitions to the grounded state, the log file 40 stores a log representing the transition.

The anti-vibration apparatus according to this embodiment can be used not only for the processing device but also for an inspection device and an exposure device. In the case of mounting an inspection device on the anti-vibration apparatus of this embodiment, even if an inspection target has no problem upon occurrence of an excessive acceleration in inspection on the inspection target that is an object, an inspection result may indicate abnormality owing to adverse effects of the excessive acceleration and the excessive vibrations. The system of the inspection device can be predetermined whether or not the inspection is continued or terminated when the setting value of each configurational element, such as the acceleration gain of the anti-vibration apparatus due to occurrence of the excessive acceleration, is switched.

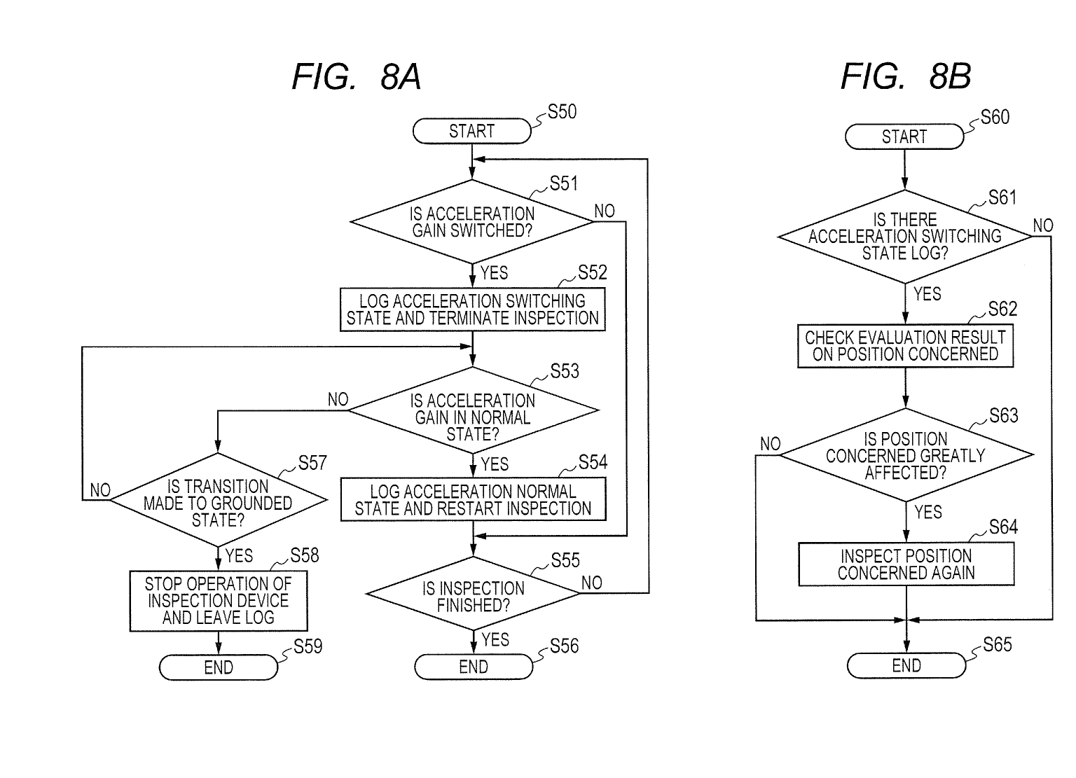

FIG. 8A illustrates a flowchart corresponding to monitoring of an inspection process on an inspection device. After monitoring of the inspection process is started (S50), it is checked whether the setting value of each configurational element, such as the acceleration gain of the anti-vibration apparatus due to occurrence of the excessive acceleration, is switched or not (S51). If the setting value has been switched (Yes in S51), the state of the inspection process is stored in a log file 40 and the inspection is terminated (S52). It is then checked whether the excessive acceleration is not detected and the setting value of each configurational element, such as the acceleration gain, is returned to the setting value at normal times (i.e., in the case without occurrence of an excessive acceleration) or not (S53). If it is verified that the setting value is returned to the setting value at normal times (Yes in S53), the state of the inspection process is stored in the log file 40 and the inspection is restarted (S54). Subsequently, it is checked whether the inspection process is finished or not (S55). If the inspection process is finished (Yes in S55), the monitoring process is finished (S56). If the inspection process is not finished (No in S55), the processing returns to step S51, and the monitoring process is continued. Meanwhile, it is checked whether the setting value is returned to the setting value at normal times or not (S53). If the setting value is not returned to the setting value at normal times (No in S53), it is then checked whether the anti-vibration apparatus transitions to the grounded state due to continuation of the excessive acceleration (S57). If the anti-vibration apparatus transitions to the grounded state (Yes in S57), the operation of the inspection device is stopped, the state of the inspection process is stored in the log file 40 (S58), and the monitoring process is finished (S59). If the anti-vibration apparatus does not transition to the grounded state (No in S57), the processing returns to step S53, and it is checked again whether the setting value is returned to the setting value at normal times or not. In step S51, it is checked the setting value of each configurational element, such as the acceleration gain of the anti-vibration apparatus due to occurrence of the excessive acceleration, is switched or not. If switching is not performed (No in S51), the processing proceeds to step S55, and it is checked whether the inspection process is finished or not. If the inspection process is finished (Yes in S55), the monitoring process is finished (S56). If the inspection process is not finished (No in S55), the processing returns to step S51, and the monitoring process is continued.

FIG. 8B illustrates a flowchart corresponding to an evaluation on a result after the inspection process by the inspection device. After the evaluation on the result of the inspection process is started (S60), it is checked whether a log is in the log file 40 or not (S61). If no log exists (No in S61), the evaluation process is finished (S65). If it is verified that a log is in the log file 40 (Yes in S61), the evaluation result at a position concerned, that is, an inspection position of the inspection target upon switching of the setting value of each configurational element of the anti-vibration apparatus due to occurrence of the excessive acceleration is checked based on the log (S62). If the position concerned is greatly affected by the excessive acceleration and the excessive vibrations (Yes in S63), the position concerned is inspected again (S64) and the evaluation process is finished (S65). In contrast, if the position concerned is not greatly affected by the excessive acceleration and the excessive vibrations (No in S63), the position concerned is not inspected again and the evaluation process is finished (S65).

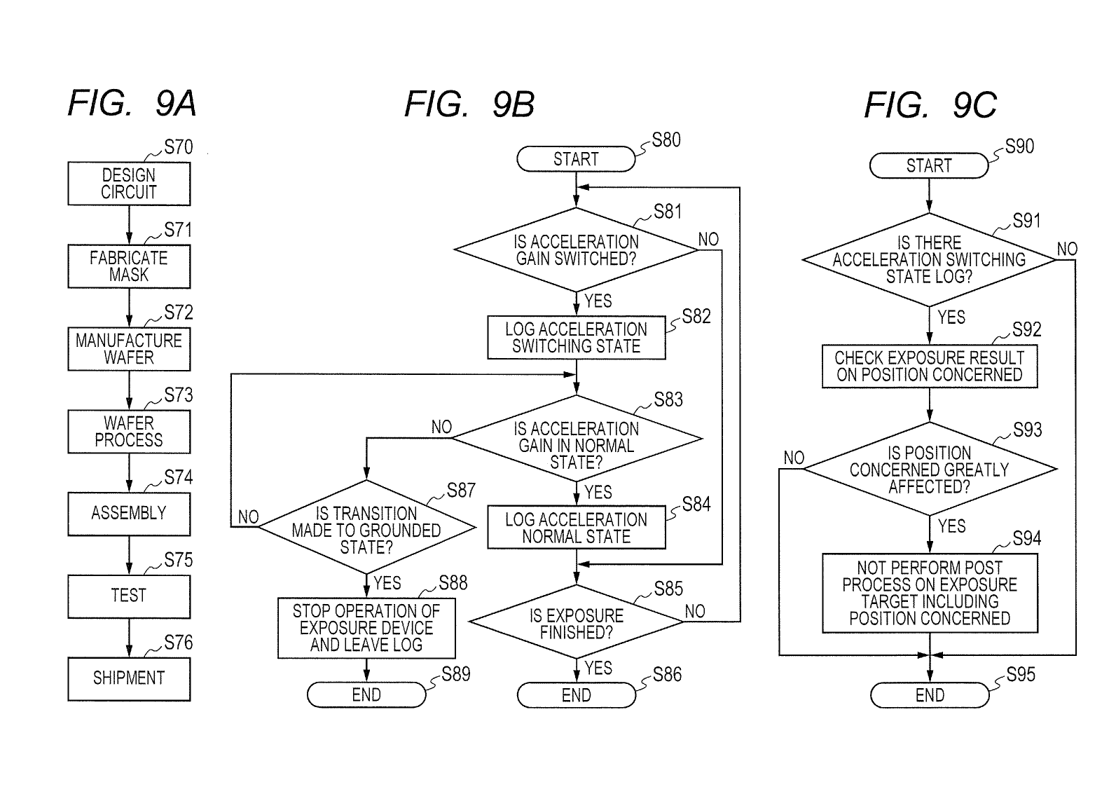

FIG. 9A is a flowchart illustrating a process of manufacturing a semiconductor chip. First, the circuit pattern of a semiconductor chip is designed (S70). Next, a mask is fabricated based on the circuit pattern designed in S70 (S71). A wafer is manufactured using material, such as silicon (S72). A circuit is formed on the wafer manufactured in S72, using the mask fabricated in S71 according to a lithography technique by an exposure device (S73). Next, based on the wafer on which the circuit is formed in S73, semiconductor chips are fabricated in assembling processes, such as an assembly process (dicing and bonding) and a packaging process (chip enclosing) (S74). An operation checking test and a durability test are performed on the fabricated semiconductor chips (S75), which are then shipped (S76).

FIG. 9B illustrates a flowchart corresponding to monitoring of an exposure process on a device by an exposure device. Here, the device may be any of semiconductor chips, such as ICs and LSIs, LCDs, and CCDs. First, after monitoring of the exposure process is started (S80), it is checked whether the setting value for each configurational element, such as the acceleration gain of the anti-vibration apparatus due to occurrence of an excessive acceleration is switched or not (S81). If the setting value has been switched (Yes in S81), the state of the exposure process is stored in a log file 40 (S82). It is then checked whether the excessive acceleration is not detected and the setting value of each configurational element, such as the acceleration gain, is returned to the setting value at normal times (i.e., in the case without occurrence of an excessive acceleration) or not (S83). If it is verified that the setting value is returned to the setting value at normal times (Yes in S83), the state of the exposure process is stored in the log file 40 (S84). Subsequently, it is checked whether the exposure process is finished or not (S85). If the exposure process is finished (Yes in S85), the monitoring process is finished (S86). If the exposure process is not finished (No in S85), the processing returns to step S81, and the monitoring process is continued. Meanwhile, it is checked whether the setting value is returned to the setting value at normal times or not (S83). If the setting value is not returned to the setting value at normal times (No in S83), it is then checked whether the anti-vibration apparatus transitions to the grounded state due to continuation of the excessive acceleration (S87). If the anti-vibration apparatus transitions to the grounded state (Yes in S87), the operation of the exposure device is stopped, the state of the exposure process is stored in the log file 40 (S88), and the monitoring process is finished (S89). If the anti-vibration apparatus does not transition to the grounded state (No in S87), the processing returns to step S83, and it is checked again whether the setting value is returned to the setting value at normal times or not. In step S81, it is checked whether the setting value of each configurational element, such as the acceleration gain of the anti-vibration apparatus due to occurrence of the excessive acceleration, is switched or not. If switching is not performed (No in S81), the processing proceeds to step S85, and it is checked whether the exposure process is finished or not. If the exposure process is finished (Yes in S85), the monitoring process is finished (S86). If the exposure process is not finished (No in S85), the processing returns to step S81, and the monitoring process is continued.

FIG. 9C illustrates a flowchart corresponding to an evaluation on a result after the exposure process on a device by the exposure device. After the evaluation on the result of the exposure process is started (S90), it is checked whether a log is in the log file 40 or not (S91). If no log exists (No in S91), the evaluation process is finished (S95). If it is verified that a log is in the log file 40 (Yes in S91), the exposure result at a position concerned, that is, an exposure position of the exposure target upon switching of the setting value of each configurational element of the anti-vibration apparatus due to occurrence of the excessive acceleration is checked based on the log (S92). If the position concerned is greatly affected by the excessive acceleration and the excessive vibrations (Yes in S93), a post-process on the exposure target including the position concerned is not performed (S94) and the evaluation process is finished (S95). In contrast, if the position concerned is not greatly affected by the excessive acceleration and the excessive vibrations (No in S93), the post-process is performed even on the exposure target including the position concerned and the evaluation process is finished (S95). Here, the post-process is the assembling step (S74), the inspection step (S75) and the shipment step (S76) after the wafer process (S73).

As described above, the active anti-vibration apparatus according to this embodiment determines the behavior of the acceleration after occurrence of an excessive acceleration. When the excessive acceleration is lost, the anti-vibration apparatus is returned to the control state at normal times (i.e., in the case without occurrence of an excessive acceleration). Accordingly, the active anti-vibration apparatus is allowed to be in a state of capable of exhibiting the maximum control performance both at normal times and upon occurrence of an excessive acceleration.

In the case of mounting the processing device on the active anti-vibration apparatus according to this embodiment, operations, such as mounting of a processing target on the processing device in the setup, and replacement of the tool of the processing device, may apply a great impact on the active anti-vibration apparatus that saturates the acceleration sensors. However, upon detection of the excessive acceleration, the acceleration detection gain is reduced, thereby maintaining the floating state, which prevents reworking where grounding occurs in the setup operation and the setup is terminated. In the case of using the mounted processing device for evaluation on processing procedures, switching of each setting value of the anti-vibration apparatus is notified to the main body of the processing device upon occurrence of an excessive acceleration, and the processing position of the processing target upon switching the setting value can be excluded from the evaluation target.

Furthermore, in the case of mounting the inspection device on the active anti-vibration apparatus according to this embodiment, switching of each setting value of the anti-vibration apparatus upon occurrence of an excessive acceleration is notified to the main body of the inspection device, and the position concerned of an inspection target upon switching the setting value can be inspected again.

Moreover, in the case of mounting the exposure device on the active anti-vibration apparatus according to this embodiment, switching of each setting value of the anti-vibration apparatus upon occurrence of an excessive acceleration is notified to the main body of the exposure device, and a pattern on a wafer subjected to exposure upon switching the setting value can be regarded as an invalid pattern.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-172736, filed Aug. 3, 2012, and No. 2013-155914, filed Jul. 26, 2013, which are hereby incorporated herein in their entirety.

### REFERENCE SIGNS LIST

1 anti-vibration table
3b, 3l, 3r air spring actuator (mount)
4a to 4f acceleration sensor
5a to 5f linear motor
6b, 61, 6r upper mount (mount)
7b, 71, 7r lower mount (mount)
10 gravity center vibration coordinate transformation operation unit
11 vibration control unit
11a high-pass filter
11b acceleration control gain
12 linear motor driving force distribution operation unit
14 acceleration amplifier
14b acceleration detection gain
15a to 15i A/D converter
16a to 16f D/A converter
17 excessive acceleration determination and switching unit
50, 60 active anti-vibration apparatus
70 processing device (device)

1. An active anti-vibration apparatus, comprising:
a mount mounted on a floor;
an anti-vibration table which is mounted on the mount and on which a device is mounted;
at least one acceleration sensor for detecting an acceleration pertaining to the anti-vibration table;
an acceleration amplifier which multiplies a signal output from the acceleration sensor by a setting value to amplify the signal;
a vibration control unit which calculates a signal for compensating the acceleration from an output of the acceleration amplifier;
a determination unit which determines whether the acceleration detected by one or more of the at least one acceleration sensor is at least a prescribed acceleration or not, and outputs a signal for changing the setting value according to the determination; and
an actuator driven according to the signal output from the vibration control unit.

2. The active anti-vibration apparatus according to claim 1, wherein the vibration control unit comprises a high-pass filter capable of changing a cutoff frequency according to the determination.

3. The active anti-vibration apparatus according to claim 1, wherein the vibration control unit comprises an acceleration control gain which is to be multiplied by a reciprocal of the setting value.

4. The active anti-vibration apparatus according to claim 1, wherein the at least one acceleration sensor is a floor acceleration sensor which detects an acceleration of the floor.

5. The active anti-vibration apparatus according to claim 1, wherein the acceleration amplifier further comprises a DC offset elimination circuit which cancels an offset voltage of a signal output from the acceleration sensor.

6. The active anti-vibration apparatus according to claim 4, further comprising a second order integrator which converts a signal output from the floor acceleration sensor into a signal corresponding to a displacement of the floor, and outputs the signal to the vibration control unit.

7. The active anti-vibration apparatus according to claim 1, wherein the actuator is a linear motor.

8. The active anti-vibration apparatus according to claim 1, further comprising:
a displacement sensor for detecting a displacement pertaining to the anti-vibration table;
a position control unit which calculates a signal for compensating the displacement based on a signal output from the displacement sensor; and
a second actuator driven according to the calculated signal for compensating the displacement.

9. The active anti-vibration apparatus according to claim 8, wherein the second actuator is an air spring actuator.

10. A processing device mounted on the active anti-vibration apparatus according to claim 1.

11. An inspection device mounted on the active anti-vibration apparatus according to claim 1.

12. An exposure device mounted on the active anti-vibration apparatus according to claim 1.

13. An anti-vibration method for suppressing vibrations of an anti-vibration table by detecting an acceleration pertaining to the anti-vibration table on which a device is mounted, calculating a signal for driving an actuator so as to compensate the acceleration based on the detected acceleration, and driving the actuator according to the calculated signal, the method comprising:
detecting an acceleration pertaining to the anti-vibration table by at least one acceleration sensor; and
if the detected acceleration is at least a prescribed acceleration,
multiplying a signal output from the acceleration sensor by a setting value to change the signal, and
calculating a signal for controlling the actuator based on the changed signal to drive the actuator.

14. The anti-vibration method according to claim 13, further comprising: providing a high-pass filter which allows a signal with at least a cutoff frequency to pass when calculating the signal for controlling the actuator; and, if the detected acceleration is at least the prescribed acceleration, increasing the cutoff frequency and performing multiplication by a reciprocal of the setting value.

15. The anti-vibration method according to claim 13, wherein when an integrated value of the detected acceleration in a prescribed time period exceeds a prescribed integrated threshold, the anti-vibration table is grounded.

16. The anti-vibration method according to claim 13, wherein the actuator is a linear motor.

17. A workpiece manufacturing method of manufacturing a workpiece by a device mounted on an anti-vibration table vibrations of which are eliminated by the anti-vibration method according to claim 13, comprising:
if the detected acceleration is at least the prescribed acceleration, terminating manufacturing of the workpiece, and, when an integrated value of the detected acceleration in a prescribed time period after the terminating is equal to or less than a prescribed integrated threshold, restarting manufacturing the workpiece; and
when the integrated value exceeds the prescribed integration threshold, stopping manufacturing the workpiece.

18. The workpiece manufacturing method according to claim 17, wherein terminating manufacturing the workpiece, restarting manufacturing the workpiece or stopping manufacturing the workpiece is stored in a log file.

19. The workpiece manufacturing method according to claim 18, further comprising, after stopping manufacturing the workpiece, processing the workpiece again according to the log file.
